(19) United States
(12) Patent Application Publication
(10) Pub. No.: US 2016/0050704 A1
(43) Pub. Date: Feb. 18, 2016

(54) IMAGE LINKING AND SHARING

(71) Applicant: LYVE MINDS, INC., Cupertino, CA (US)

(72) Inventors: Andreas von Sneidern, San Jose, CA (US); Kevin Arnold, Cupertino, CA (US); Jeff Ma, Cupertino, CA (US); Mihnea Calin Pacurariu, Los Gatos, CA (US)

(21) Appl. No.: 14/821,305

(22) Filed: Aug. 7, 2015

Related U.S. Application Data
(60) Provisional application No. 62/036,195, filed on Aug. 12, 2014.
(60) Provisional application No. 62/134,244, filed on Mar. 17, 2015.

(51) Int. Cl. H04W 76/02; H04N 1/00

(52) U.S. Cl. CPC H04W 76/023; H04N 1/00137; H04N 1/00148; H04N 1/00307

(57) ABSTRACT

According to one or more embodiments of the present disclosure, a method may include receiving, from a first wireless device, a wireless beacon signal that corresponds to an event. The method may further include communicating, by a second wireless device, an indication of participation in image sharing with respect to the event in response to receiving the wireless beacon signal. Additionally, the method may include receiving, by the second wireless device, one or more image files that correspond to one or more images captured during the event based on the indication of participation in the image sharing.

### CROSS-REFERENCE TO RELATED APPLICATIONS

This application is based upon and claims the benefit of priority of U.S. Provisional Application No. 62/036,195, filed on Aug. 12, 2014, and of U.S. Provisional Application No. 62/134,244, filed on Mar. 17, 2015. The forgoing applications are incorporated herein by reference in their entirety.

### FIELD

The embodiments discussed in the present disclosure are related to linking and sharing of images.

### BACKGROUND

Digital video and photographs are increasingly ubiquitous and created by any number of cameras. The cameras may be integrated in multi-purpose devices such as tablet computers and mobile phones or may be standalone devices whose primary purpose is the creation of digital video and photographs. Often different people may take pictures and/or video during an event and like to share those pictures and videos with others who also attended the event.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to one or more embodiments of the present disclosure, a method may include receiving, from a first wireless device, a wireless beacon signal that corresponds to an event. The method may further include communicating, by a second wireless device, an indication of participation in image sharing with respect to the event in response to receiving the wireless beacon signal. Additionally, the method may include receiving, by the second wireless device, one or more image files that correspond to one or more images captured during the event based on the indication of participation in the image sharing.

The object and advantages of the embodiments will be realized and achieved at least by the elements, features, and combinations particularly pointed out in the claims.

It is to be understood that both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates a block diagram of an example system configured to register an event and to generate a mechanism for sharing images that may be captured during the event;

FIG. 1B illustrates an example process that may be performed by the system of FIG. 1A;

FIG. 2A illustrates a block diagram of an example system configured to register users with respect to sharing of images that may be captured during an event;

FIG. 2B illustrates an example process corresponding to registering a user as a participant in image sharing;

FIG. 2C illustrates another example process corresponding to registering a user as a participant in image sharing;

FIG. 2D illustrates another example process corresponding to registering a user as a participant in image sharing;

FIG. 3A illustrates a block diagram of an example system configured to facilitate image sharing associated with an event;

FIG. 3B illustrates an example process configured to facilitate image sharing with respect to an event;

FIG. 3C illustrates another example process configured to facilitate image sharing with respect to an event;

FIG. 4A illustrates a block diagram of an example system configured to perform image sharing associated with an event;

FIG. 4B illustrates an example process configured to share images with respect to an event; and

FIG. 5 illustrates a block diagram of an example computing system.

FIG. 6 illustrates a block diagram of an example system configured to link images based on the images being captured during the same event;

FIG. 7 illustrates an example electronic device that may be configured to capture images that may be linked based on events; and

FIG. 8 is a flowchart of an example method of linking images.

### DESCRIPTION OF EMBODIMENTS

Often multiple pictures and/or video are taken by attendees of an event such as a sporting event, a concert, a play, a dance recital, a vacation, a party, an activity, etc. and may take pictures and/or video of the event. Often people like to share and/or link pictures and/or video taken during events.

According to at least one embodiment described in the present disclosure, systems and methods may be configured to automatically distribute images (e.g., pictures and/or videos) captured during an event to attendees of the event such that the images may be shared between the attendees. The automatic distribution of the images may include less user involvement and time than other technologies used to share images such that it may improve upon existing image sharing technologies.

In these or other embodiments, image files associated with images may include metadata such as geolocation data, audio data, voice tag data, motion data, biological data, temperature data, a time stamp, a date stamp, user tag data, barometric pressure data, people data, and/or camera orientation data. The metadata of the image files may be compared and analyzed to determine whether the corresponding images are likely associated with the same event. The images that are deemed to likely be associated with the same event based on the metadata may be linked such that the images may be organized or shared according to the event.

In the present disclosure, discussion of sharing, storing, linking, and/or distributing images may refer to sharing, storing, linking and/or distributing image files that may include representations of the images. The image files may include an original image file, a compressed image file (e.g., a thumbnail), a copy of the original image file, a video file, a still image file, or any suitable combination thereof.

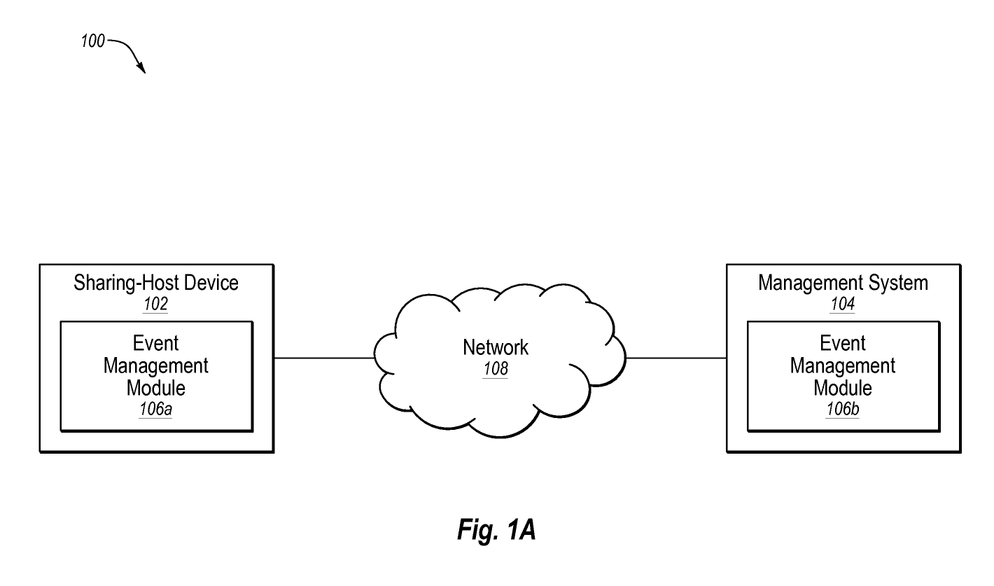

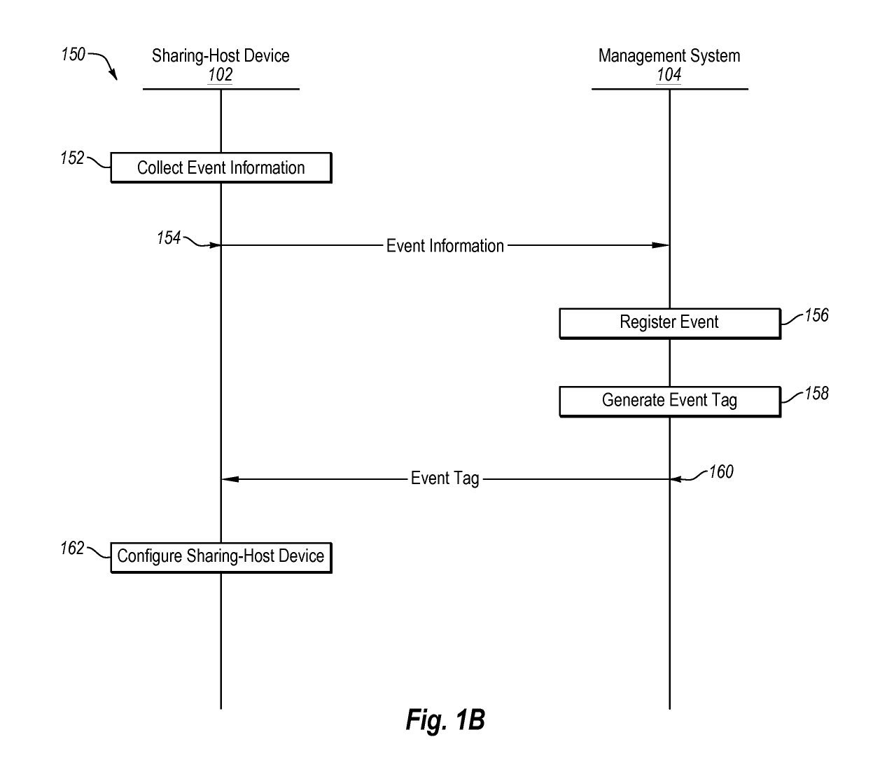

FIG. 1A illustrates a block diagram of an example system 100 configured to register an event and to generate a mechanism for sharing images (“image-sharing mechanism”) that may be captured during the event, according to at least one embodiment of the present disclosure. The system 100 may include a sharing-host device 102, a management system 104, and a network 108.

The management system 104 may include any suitable system that may be configured to perform information processing. For example, the management system 104 may include a server, a server system, a mobile phone, a tablet computer, a desktop computer, a laptop computer, a camera, a personal digital assistant (PDA), a smartphone, a music player, a video player, etc.

In some embodiments, the management system 104 may be configured to direct a data management service that may be provided to users of the data management service. In some embodiments, the data management service may be configured to manage storage and distribution of images across one or more devices of one or more of the users (“user devices”) such that the images may be stored on and available with respect to the user devices. For example, the data management service may direct the storage, linking and/or access of images acquired by a particular user across different devices that may include corresponding data management software stored thereon and that may be registered to the particular user (e.g., via being logged in to an account of the particular user via the image management software).

The sharing-host device 102 may also include any electronic device that may be configured to perform information processing and that may be used by an image-sharing host of an event (“sharing host”). For example, the sharing-host device 102 may include a mobile phone, a tablet computer, a desktop computer, a laptop computer, a camera, a personal digital assistant (PDA), a smartphone, a music player, a video player, etc. In some embodiments, the sharing host of the event may be a user of the data management service. Additionally, in the present disclosure, the sharing host may include any entity that may establish an image-sharing mechanism and/or registration such that images captured during a corresponding event may be shared. Further, the sharing host may or may not be the actual host of the event.

In some embodiments, the sharing-host device 102 and/or the management system 104 may include an event management module. In the illustrated example, the sharing-host device 102 may include an event management module 106a and the management system 104 may include an event management module 106b.

The event management modules 106 may include code and routines configured to enable or cause a computing system to perform operations related to sharing or linking images that may be captured during an event. Additionally or alternatively, the event management module 106 may be implemented using hardware including a processor, a microprocessor (e.g., to perform or control performance of one or more operations), a field-programmable gate array (FPGA), or an application-specific integrated circuit (ASIC). In some other instances, the event management modules 106 may be implemented using a combination of hardware and software. In the present disclosure, operations described as being performed by the event management modules 106 may include operations that the event management modules 106 may direct a corresponding system or device to perform.

In some embodiments, the event management modules 106 may be included with data management software that may be associated with the data management service. For example, data management software of which the event management module 106a may be included may be registered to an account of the sharing host with respect to the data management service. In particular, in some embodiments, the sharing host may provide the data management software with login information (e.g., a username and password) with respect to the data management service. As such, the event management module 106a and the sharing-host device 102 may be linked with the account of the sharing host with respect to the data management service.

In some embodiments, the sharing-host device 102 and the management system 104 may be configured to communicate with each other via any suitable wired and/or wireless mechanisms, Internet connectivity, Local Area Network (LAN) connectivity, Wide Area Network (WAN) connectivity, Bluetooth® connectivity, 3G connectivity, 4G connectivity, LTE connectivity, Wireless Fidelity (Wi-Fi) connectivity, Machine-to-Machine (M2M) connectivity, Device-to-Device (D2D) connectivity, any other suitable communication capability, or any suitable combination thereof.

In the illustrated embodiment, the sharing-host device 102 and the management system 104 may be configured to communicate with each other via a communication network 112 (referred to hereinafter as “network 112”). In some embodiments, the network 112 may include, either alone or in any suitable combination, the Internet, an Intranet, a local Wi-Fi network, a wireless LAN, a mobile network (e.g., a 3G, 4G, and/or LTE network), a LAN, a WAN, or any other suitable communication network.

In some embodiments, the sharing-host device 102 and the management system 104 may be configured to perform operations associated with registering an event (e.g., via the event management module 106a and the event management module 106b). Additionally or alternatively, the sharing-host device 102 and the management system 104 may be configured to perform operations associated with establishing a mechanism configured for sharing images that may be captured during the event (e.g., via the event management module 106a and the event management module 106b).

FIG. 1B illustrates an example process 150 that may be performed by the sharing-host device 102 and the management system 104, according to at least one embodiment described in the present disclosure. The process 150 may be used to register an event for sharing images associated with the event and/or to establish a mechanism for sharing images associated with the event. In some embodiments, one or more operations of the process 150 may be directed by one or more event management modules (e.g., the event management modules 106).

In the present example, the process 150 is described with respect to operations that may be performed by the sharing-host device 102 and the management system 104. One or more of such operations that may be described as being performed by the sharing-host device 102 or the management system 104 may be directed by the event management modules 106a and 106b, respectively.

Although illustrated and described with respect to a particular sequence, the operations described with respect to the process 150 may be performed in a different order in some embodiments. Additionally, one or more operations may be added to or removed from each operation described.

The process 150 may include an operation 152 at which the sharing-host device 102 may collect information with respect to an event (“event information”). In some embodiments, the event management module 106a may be configured to allow a user to indicate the occurrence of an event. In these or other embodiments, the event management module 106a may query the user to input the event information in response to the indication of the occurrence of the event.

The event information may include any information that may pertain to the event. For example, the event information may include a time, a date, and a location of the event. Additionally, in some embodiments, the event information may include a list of one or more attendees or invitees of the event and corresponding information. The information of the attendees or invitees may include names, email addresses, phone numbers (e.g., mobile numbers), etc. In these or other embodiments, one or more of the attendees or the invitees may also include users of the data management service. Additionally or alternatively, identifiers (e.g., usernames, email addresses, etc.) that may link the attendees or invitees to the data management service may be included with the event information.

At an operation 154, the sharing-host device 102 may communicate (e.g., via the network 108 of FIG. 1A) the event information to the management system 104. At an operation 156, the management system 104 may register the event based on the event information. For example, the management system 104 may store event information and generate and store a corresponding event identifier with respect to the event. The event identifier may include a unique identifier that may be unique to the event.

At an operation 158, the management system 104 may generate an event tag. The event tag may include a tag that may be unique to the event. For example, in some embodiments, the event tag may include the unique identifier that may be generated for the event. As discussed in further detail below, in some embodiments, the event tag may be a mechanism that may be used to share images associated with the event. For example, the event tag may be included in metadata of image files that correspond to images that may be captured during the event. The event tag may then be used to identify images that may be captured during the event such that the images may be shared among attendees of the event, as discussed in detail below. At an operation 160, the management system 104 may communicate (e.g., via the network 108 of FIG. 1A) the event tag to the sharing-host device 102.

In some embodiments, the process 150 may include an operation 162. At the operation 162, the sharing-host device 102 may be configured to participate in image sharing with respect to the event. In some embodiments, the sharing-host device 102 may be configured to participate in the image sharing with respect to the event in response to the sharing-host device 102 initiating registration of the event. In some embodiments, the sharing-host device 102 may be configured to participate in the image sharing with respect to the event based on the event information and/or the event tag.

For example, in some embodiments, the sharing-host device 102 may include a camera such that the sharing-host device 102 may be configured to capture images such that images captured by the sharing-host device 102 during the event may be shared. Further, the event management module 106a may be configured to acquire location information of the sharing-host device 102. Additionally or alternatively, the event management module 106a may also be configured to acquire current date and time information (e.g., from one or more other applications that may be included on the sharing-host device 102). The event management module 106a may be configured to compare one or more of the location information, the date information, and the time information with event location information, event date information, and/or event time information that may be included in the event information. Additionally or alternatively, the event management module 106a may be configured to determine whether or not the sharing-host device 102 is at the event based on the comparison. In some embodiments, in response to determining that the sharing-host device 102 is at the event, the event management module 106a may include the event tag in the metadata of images captured by the sharing-host device 102. As detailed below, the inclusion of the event tag in the metadata may facilitate the sharing of images. Therefore, the sharing-host device 102 may be configured to participate in image sharing by being configured to determine when to tag images with the event tag.

Additionally or alternatively, in some embodiments configuration of the sharing-host device 102 may include configuring the sharing-host device 102 to transmit a wireless beacon signal that may indicate the event and the availability of image sharing with respect to the event. The transmission of the beacon signal and associated operations are described in further detail below.

Accordingly, the process 150 may be used by the system 100 to register an event for sharing images associated with the event and/or to establish a mechanism for sharing images associated with the event. Modifications, additions, or omissions may be made to the process 150 without departing from the scope of the present disclosure. For example, in some embodiments, the order and/or location of operations that may be performed may vary. For example, in some embodiments, the event tag and/or event identifier may be generated at the sharing-host device 102 (e.g., as directed by the event management module 106a) instead of at the management system 104. In these or other embodiments, the sharing-host device 102 may communicate the event tag and/or the event identifier to the management system 104.

In addition, in some embodiments, additional sharing-host devices may be associated with the sharing host and may include an event management module stored thereon. In these or other embodiments, the management system 104 and/or the sharing-host device 102 may communicate event information to the additional sharing-host devices such that the additional sharing-host devices may also be configured to participate in image sharing associated with the event.

Further, modifications, additions, or omissions may be made to the system 100 without departing from the scope of the present disclosure. For example, the specific designations of operations with respect to the sharing-host device 102 and the management system 104 are given as examples and are not limiting. In some instances a same device or system may perform one or more operations as an event-host device and may perform one or more other operations as a management system. Further, in the present disclosure, a particular event management module 106 may be configured to direct different operations depending on which device or system it may be stored. Additionally or alternatively, a particular event management module 106 may be configured to direct different operations depending on a particular role that may be performed with respect to a particular device or system on which it may be stored.

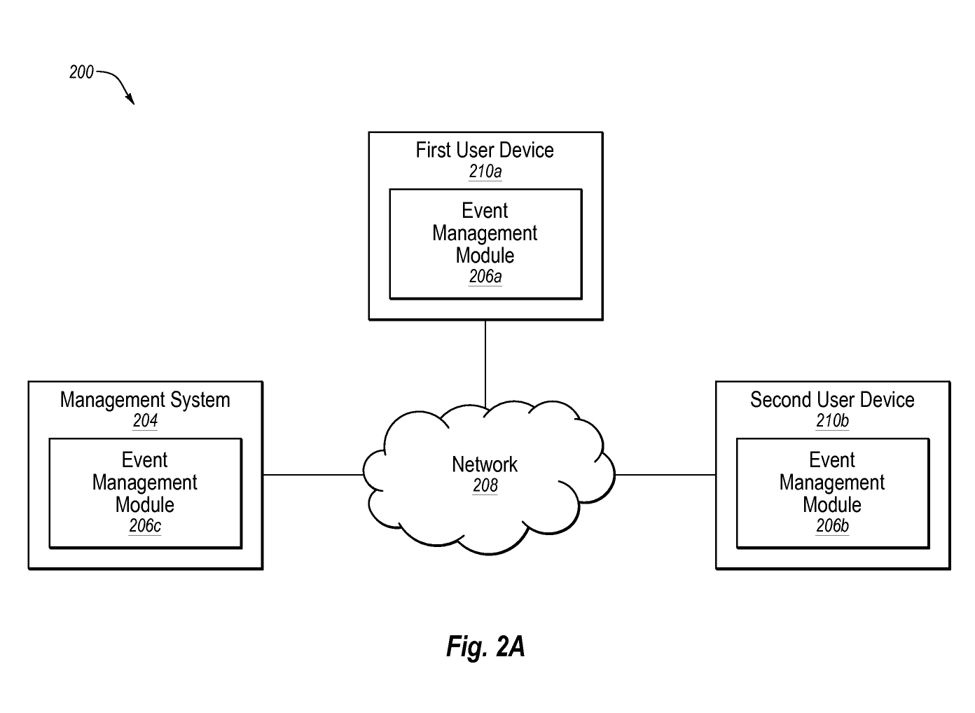

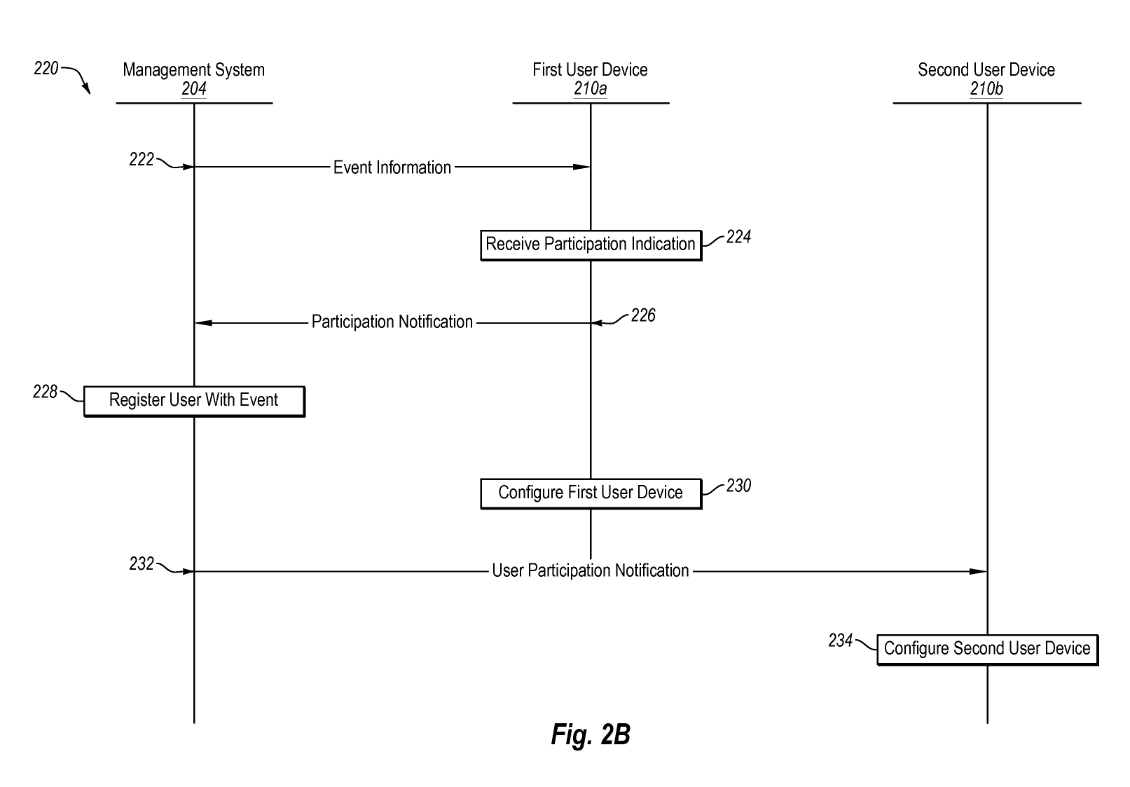

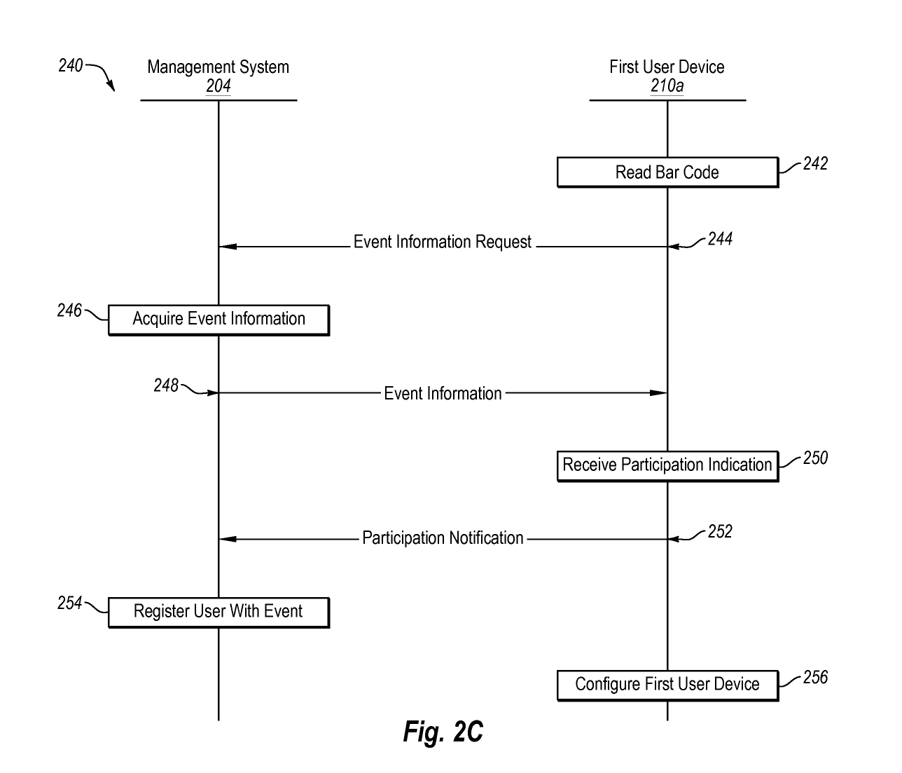

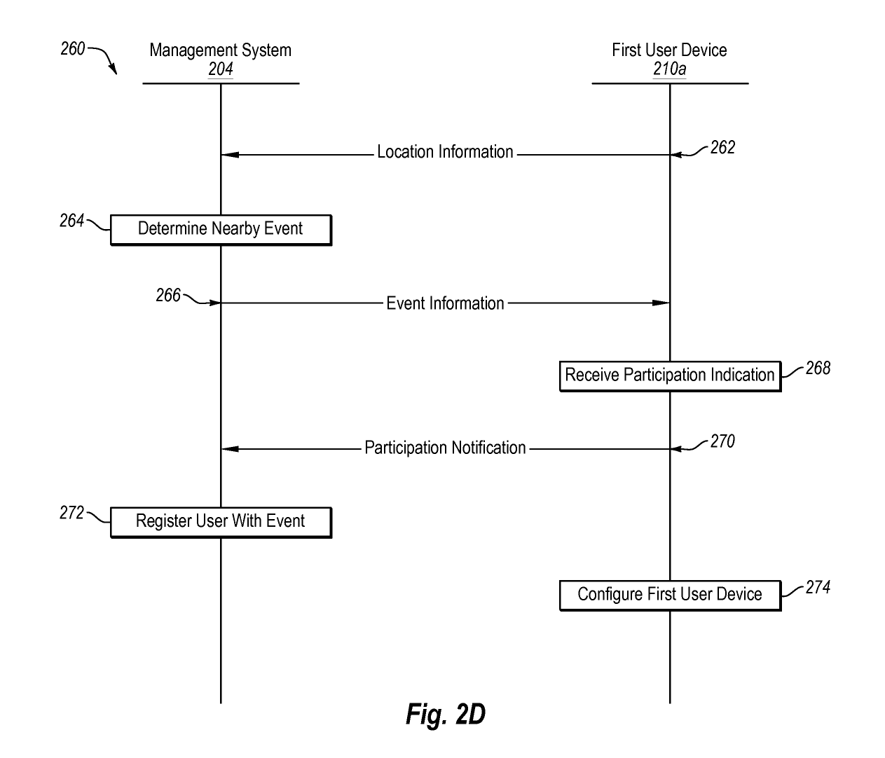

FIG. 2A illustrates a block diagram of an example system 200 configured to register users with respect to sharing of images that may be captured during an event, according to at least one embodiment of the present disclosure. The system 200 may include a management system 204, a network 208, and one or more user devices. In the illustrated embodiment, the system 200 is depicted as including a first user device 210a and a second user device 210b.

The management system 204 may be analogous to the management system 104 of FIGS. 1A and 1B. Further, the network 208 may be analogous to the network 108 described with respect to FIG. 1A.

The user devices 210 may include any electronic device that may be configured to perform information processing and that may be used by a user of a data management service. For example, the user devices 210 may include a mobile phone, a tablet computer, a desktop computer, a laptop computer, a camera, a personal digital assistant (PDA), a smartphone, a music player, a video player, etc. In some embodiments, the users of the user devices 210 may be invitees or attendees of the event. Further, in some embodiments, the first user device 210a and the second user device 210b may be associated with the same user or with different users.

In some embodiments, the first user device 210a may include an event management module 206a, the second user device 210b may include an event management module 206b, and the management system 204 may include an event management module 206c. The event management modules 206 may include analogous or similar structures as those described with respect to the event management modules 106 described with respect to FIG. 1A.

In some embodiments, the event management modules 206 may be included with data management software that may be associated with the data management service. For example, data management software of which the event management module 206a may be included may be registered to a first account of a first user of the first user device 210a and data management software of which the event management module 206b may be included may be registered to a second account of a second user of the second user device 210b. As another example, the first user device 210a and the second user device 210b may be of a same particular user and the data management software of which the event management modules 206a and 206b may be included may both be registered to an account of the particular user.

In some embodiments, the event management modules 206 may be configured to direct operations of their respective devices or systems such that their respective users may be registered as participants in image sharing with respect to an event. In some embodiments, images captured during a particular event by a participant may be shared with other participants, as discussed in further detail below.

FIG. 2B illustrates an example process 220 corresponding to registering a user as a participant in image sharing, according to at least one embodiment described in the present disclosure. The process 220 may also include configuring one or more user devices of the registered user for image sharing participation. In some embodiments, one or more operations of the process 220 may be directed by one or more event management modules (e.g., one or more event management modules 206).

In the present example, the process 220 is described with respect to operations that may be performed by the management system 204, the first user device 210a, and the second user device 210b. One or more of such operations that may be described as being performed by the management system 204, the first user device 210a, or the second user device 210b may be directed by the event management modules 206c, 206a, or 206b, respectively.

Although illustrated and described with respect to a particular sequence, the operations described with respect to the process 220 may be performed in a different order, in some embodiments. Additionally, one or more operations may be added to or removed from each operation described. In the present example, the process 220 describes operations that may be performed after an event has been registered, such as described with respect to the process 150 of FIG. 1B.

The process 220 may include an operation 222 at which the management system 204 may communicate (e.g., via the network 208) event information associated with a registered event to the first user device 210a. In some embodiments, the management system 204 may communicate the event information to the first user device 210a in response to user information of a user of the first user device 210a being included in an invitee list of the registered event that may be provided by a sharing host of the registered event.

In these or other embodiments, the event information may be communicated to an email account of the user of the first user device 210a that may be included in the user information. Further, the user may access the email account on the first user device 210a such that the event information may be communicated to the first user device 210a via the communication to the email account and access of the email account on the first user device 210a.

Additionally or alternatively, the event information may be communicated to an account of the user that corresponds to a data management service of which the management system 204 and the event management module 206a may be associated. For example, the user information may include a username of the user with respect to the data management service such that the management system 204 may link the event information to the account of the user based on the username. In these or other embodiments, the management system 204 may be configured to communicate the event information to the event management module 206a based on the linking of the event information to the account of the user.

In these or other embodiments the first user information may include a mobile number of the user and the management system 204 may be configured to communicate the event information to the event management module 206a via a text message that may be communicated to the first user device 210a.

In some embodiments, the event information may include an invitation for the user to participate in image sharing with respect to the event. In some embodiments, the invitation and event information may be presented to the user via a display of the first user device 210a.

At an operation 224 of the process 220, the first user device 210a may receive an indication from the user that may indicate whether or not the user accepts or declines to participate in the image sharing. In some embodiments, the indication may be received via a user input that may be provided via any acceptable user input device, system, or mechanism.

Additionally or alternatively, the participation indication may indicate a degree of participation by the user. For example, the participation indication may indicate that images captured by other participants in the image sharing during the event may be shared with the user and that images captured by the user may also be shared with the other participants. As another example, the participation indication may indicate that images captured by the other participants during the event may be shared with the user but that images captured by the user may not be shared with the other participants. As another example, the participation indication may indicate that images captured by the other participants during the event may be not shared with the user and that images captured by the user may be shared with the other participants. As another example, the participation indication may indicate that the user may select which images to share with other participants. In these or other embodiments, the participation indication may indicate whether to communicate all images to the user or whether to communicate previews of images to the user and to allow the user to select which images to receive from the previews of images.

At an operation 226, the first user device 210a may communicate (e.g., via the network 208) a participation notification to the management system 204. In some embodiments, the participation notification may indicate whether or not the user accepts or declines to participate in the image sharing. In these or other embodiments, the participation notification may indicate a degree of participation by the user. In some embodiments, the participation notification may be communicated only in instances when the user accepts to participate in the image sharing (referred to as an “accept notification”). In other embodiments, the participation notification may be communicated only in instances when the user declines to participate in the image sharing (referred to as a “decline notification”).

At an operation 228, the management system 204 may register the user with the event and the corresponding image sharing. In some embodiments, the user may be registered in response to receiving an accept notification, which may be referred to as “opt-in participation.” In these or other embodiments, the user may be registered in response to not receiving a decline notification, even if an accept notification is not received, which may be referred to as “opt-out participation.” In some embodiments, the sharing host may indicate whether or not the participation in image sharing with respect to a particular event is an opt-in participation or an opt-out participation.

Additionally or alternatively, the user of the first user device 210a may indicate a default setting as to whether or not participation by the user in image sharing may be treated as opt-in participation or opt-out participation. In these or other embodiments, the management system 204 may register the user with the event according to the default setting, unless directed otherwise according to the participation notification. In these or other embodiments, the event management module 206a of the first user device 210a may be configured to communicate an accept notification or a decline notification at operation 226 based on the default setting.

Registration of the user may include providing an indication with respect to the user's account with the data management service that the user is a participant in the image sharing with respect to the event. As discussed in detail below, the indication of participation may be used to share with the user (e.g., via user devices of the user) images that may be captured by other image sharing participants during the event. Additionally or alternatively, the indication of participation may also be used to share images that may be captured by the user during the event with other image sharing participants.

In some embodiments, the process 220 may include an operation 230. At the operation 230, the first user device 210a may be configured to participate in image sharing with respect to the event. In some embodiments, the first user device 210a may be configured to participate in the image sharing in response to receiving an acceptance from the user to participate in image sharing. In these or other embodiments, the first user device 210a may be configured to participate in the image sharing in response to the user having a default opt-in participation setting. The configuration of the first user device 210a to participate in image sharing with respect to the event may be analogous to the configuration of the sharing-host device 102 described in FIG. 1B with respect to the operation 162 of the process 150 of FIG. 1B.

In some embodiments, the process 220 may also include an operation 232. At the operation 232, a notification of user participation in image sharing with respect to the event may be communicated to one or more other user devices of the user. For example, in the illustrated example, the second user device 110b of FIG. 2A may be associated with the same user as the first user device 110a. At operation 232, the management system 204 may communicate (e.g., via the network 208) the user participation notification to the second user device 110b. In some embodiments, the first user device 210a may communicate (e.g., via the network 208) the user participation notification to the second user device 110b instead of or in addition to the management system 204 communicating the user participation notification.

In some embodiments, the communication of the user participation notification to the second user device 210b may be based on the second user device 210b being registered with respect to the user. For example, the event management module 206b may be configured to be logged in to the account of the user with respect to the data management service such that the second user device 210b may be registered with respect to the user.

In these or other embodiments, the process 220 may include an operation 234. At the operation 234, the second user device 210b may be configured to participate in image sharing with respect to the event. In some embodiments, the second user device 210b may be configured to participate in the image sharing in response to receiving the user participation notification. The configuration of the second user device 210b to participate in image sharing with respect to the event may be analogous to the configuration of the sharing-host device 102 described in FIG. 1B with respect to the operation 162 of the process 150 of FIG. 1B.

Accordingly, the process 220 may be used to register users with respect to sharing of images that may be captured during an event. Modifications, additions, or omissions may be made to the process 220 without departing from the scope of the present disclosure. For example, in some embodiments, the order and/or location as to where operations may be performed may vary. In addition, in some embodiments, additional user devices of the user may be notified of the participation and/or configured than those specifically described.

FIG. 2C illustrates another example process 240 corresponding to registering a user as a participant in image sharing, according to at least one embodiment described in the present disclosure. The process 240 may also include configuring one or more user devices of the registered user for image sharing participation. In some embodiments, one or more operations of the process 240 may be directed by one or more event management modules (e.g., one or more event management modules 206).

In the present example, the process 240 is described with respect to operations that may be performed by the management system 204 and the first user device 210a. One or more of such operations that may be described as being performed by the management system 204 and the first user device 210a may be directed by the event management modules 206c or 206a, respectively.

Although illustrated and described with respect to a particular sequence, the operations described with respect to the process 240 may be performed in a different order, in some embodiments. Additionally, one or more operations may be added to or removed from each operation described. In the present example, the process 240 describes operations that may be performed after an event has been registered, such as described with respect to the process 150 of FIG. 1B.

The process 240 may include an operation 242 at which the first user device 210a may read a barcode. In some embodiments, the barcode may include a linear barcode or a matrix (2D) barcode (e.g., a QR code). In some embodiments, the event management module 206a of the first user device 210a may provide the first user device 210a with the functionality to read the barcode. Additionally or alternatively, the functionality may be provided via another application or mechanism associated with the first user device 210a.

The barcode may include event information with respect to a registered event. In some embodiments, the information included in the barcode may include a unique identifier of the event. In these or other embodiments, the information included in the barcode may include other event information such as an event time, an event location, an event date, an event tag, etc.

In some embodiments, the barcode may include an indication of the event (e.g., a unique event identifier) and a web address (e.g., a Uniform Resource Locator (URL) Address) but not additional event information. Additionally, the web address may direct to a connection with the management system 204. In these or other embodiments, the process 240 may include an operation 244 at which the first user device 210a may communicate an event information request. In some embodiments, the event information request may include an inquiry for additional event information. In these or other embodiments, the event information request may include the event identifier included in the barcode and may be directed to the management system 204 based on the web address that may be included in the barcode.

In these or other embodiments, the process 240 may include an operation 246, at which the management system 204 may acquire event information. In some embodiments, the management system 204 may be configured to acquire the event information in response to receiving the event information request. Additionally or alternatively, the management system 204 may be configured to acquire the event information based on the event identifier that may be included in the event information request.

For example, in some embodiments, the management system 204 may compare the event identifier included in the event information request with one or more event identifiers stored thereon. The management system 204 may then acquire event information that may correspond to and that may be stored with respect to the matching event identifier.

In some embodiments, the process 240 may include an operation 248. At the operation 248, the management system 204 may communicate (e.g., via the network 208) the event information to the first user device 210a. In some embodiments, the management system 204 may communicate the event information to the first user device 210a in response to acquiring the event information in response to receiving the event information request.

In these or other embodiments, the event information may be communicated to an email account of the user of the first user device 210a that may be included in the user information, such as described with respect to operation 222 of FIG. 2B. Additionally or alternatively, the event information may be communicated to an account of the user with respect to the data management service, such as also described with respect to operation 222 of FIG. 2B. In these or other embodiments, the event information may be included in a text message communicated to the first user device 210a. In some embodiments, the event information may include an invitation for the user to participate in image sharing with respect to the event. In some embodiments, the invitation and event information may be presented to the user.

In some embodiments, one or more of the operations 244, 246, and 248 may be omitted from the process 240. For example, in some embodiments, the event information, including an invitation to participate in image sharing, may be included in the barcode that may be read at operation 242. Accordingly, in these or other instances, the operations 244, 246, and 248 may be omitted because the first user device 210a may have already acquired the event information from the barcode instead of the management system 204.

At an operation 250 of the process 240, the first user device 210a may receive an indication from the user that may indicate whether or not the user accepts or declines to participate in the image sharing. The operation 250 may be analogous to the operation 224 of the process 220 of FIG. 2B.

At an operation 252, the first user device 210a may communicate (e.g., via the network 208) a user participation notification to the management system 204. The operation 252 may be analogous to the operation 226 of the process 220 of FIG. 2B.

At an operation 254, the management system 204 may register the user with the event and the corresponding image sharing. The operation 254 may be analogous to the operation 228 of the process 220 of FIG. 2B.

In some embodiments, the process 240 may include an operation 256. At the operation 256, the first user device 210a may be configured to participate in image sharing with respect to the event. The operation 256 may be analogous to the operation 230 of the process 220 of FIG. 2B.

Accordingly, the process 240 may be used to register users with respect to sharing of images that may be captured during an event. Modifications, additions, or omissions may be made to the process 240 without departing from the scope of the present disclosure. For example, in some embodiments, the order and/or location as to where operations may be performed may vary. In addition, in some embodiments, additional user devices of the user may be notified of the participation and/or configured than those specifically described.

Additionally, in some embodiments, the process 240 may also include one or more operations analogous to operation 232 of the process 220 of FIG. 2B in which a user participation notification may be communicated to one or more other user devices associated with the user of the first user device 210a. In these or other embodiments, the process 240 may include one or more operations with respect to configuring the other user devices.

FIG. 2D illustrates another example process 260 corresponding to registering a user as a participant in image sharing, according to at least one embodiment described in the present disclosure. The process 260 may also include configuring one or more user devices of the registered user for image sharing participation. In some embodiments, one or more operations of the process 260 may be directed by one or more event management modules (e.g., one or more event management modules 206).

In the present example, the process 260 is described with respect to operations that may be performed by the management system 204 and the first user device 210a. One or more of such operations that may be described as being performed by the management system 204 and the first user device 210a may be directed by the event management modules 206c or 206a, respectively.

Although illustrated and described with respect to a particular sequence, the operations described with respect to the process 260 may be performed in a different order, in some embodiments. Additionally, one or more operations may be added to or removed from each operation described. In the present example, the process 260 describes operations that may be performed after an event has been registered, such as described with respect to the process 150 of FIG. 1B.

The process 260 may include an operation 262 at which the first user device 210a may communicate location information to the management system 204. In some embodiments, the first user device 210a may be configured to periodically communicate its location information to the management system 204. The first user device 210a may be configured to acquire its location for communication to the management system 204 using any suitable process, system, or mechanism. For example, in some embodiments, the first user device 210a may be configured to acquire its location for communication to the management system 204 using a global positioning system (GPS). Additionally or alternatively, the first user device 210a may be configured to acquire or estimate its location based on wireless communication access points (e.g., cellular towers, base stations, wireless routers, etc.) with which the first user device 210a may be communicating.

The process 260 may include an operation 264, at which the management system 204 may determine a nearby event with respect to the first user device 210a. In some embodiments, the management system 204 may be configured to determine whether or not the first user device 210a is within the vicinity of any events. In these or other embodiments, the management system 204 may make the determination based on event information associated with one or more registered events, a current location of the first user device 210a (e.g., as determined from the received location information), a current time, and/or a current date.

For example, in some embodiments, the management system 204 may be configured to compare the current location, the current time, and the current date with event locations, event times, and event dates of registered events. Based on the comparison, the management system 204 may be configured to determine whether or not the first user device 210a is within an area that may be near a currently occurring event. In some embodiments, the area that may be considered “near” a currently occurring event may be based on whether or not the area is within a particular distance from the currently occurring event. As such, in some embodiments, the management system 204 may be configured to determine one or more events that may be near the first user device 210a when the first user device 210a is in fact within the vicinity of those events.

In some embodiments, the determination as to whether or not the first user device 210a is within the “vicinity” of a particular event may be based on one or more characteristics of an area where the particular event may be held. For example, a first particular event location of a first particular event may include a relatively low density of people, such as a privately owned ranch. Additionally, a second particular event location of a second particular event may include an area with a relatively high density of people, such as an apartment building. As such, in some embodiments, a first area that may be considered to be within the vicinity of the first event may be larger than a second area that may be considered to be within the vicinity of the second event.

In some embodiments, the process 260 may include an operation 266. At the operation 266, the management system 204 may communicate (e.g., via the network 208) event information associated with the nearby event or events to the first user device 210a. In some embodiments, the management system 204 may communicate the event information to the first user device 210a in response to determining that the first user device 210a is within the vicinity of one or more events.

In these or other embodiments, the event information may be communicated to an email account of the user of the first user device 210a that may be included in the user information, such as described with respect to operation 222 of FIG. 2B. Additionally or alternatively, the event information may be communicated to an account of the user with respect to the data management service, such as also described with respect to operation 222 of FIG. 2B. In some embodiments, the event information may include an invitation for the user to participate in image sharing with respect to the nearby event or events. In some embodiments, the invitation and event information may be presented to the user.

At an operation 268 of the process 260, the first user device 210a may receive an indication from the user that may indicate whether or not the user accepts or declines to participate in the image sharing. The operation 268 may be analogous to the operation 224 of the process 220 of FIG. 2B.

At an operation 270, the first user device 210a may communicate (e.g., via the network 208) a participation notification to the management system 204. The operation 270 may be analogous to the operation 226 of the process 220 of FIG. 2B.

At an operation 272, the management system 204 may register the user with the event and the corresponding image sharing. The operation 272 may be analogous to the operation 228 of the process 220 of FIG. 2B.

In some embodiments, the process 260 may include an operation 274. At the operation 274, the first user device 210a may be configured to participate in image sharing with respect to the event. The operation 274 may be analogous to the operation 230 of the process 220 of FIG. 2B.

Accordingly, the process 260 may be used to register users with respect to sharing of images that may be captured during an event. Modifications, additions, or omissions may be made to the process 260 without departing from the scope of the present disclosure. For example, in some embodiments, the order and/or location as to where operations may be performed may vary. In addition, in some embodiments, additional user devices of the user may be notified of the participation and/or configured than those specifically described.

Additionally, in some embodiments, the process 260 may also include one or more operations analogous to operation 232 of the process 220 of FIG. 2B in which a user participation notification may be communicated to one or more other user devices associated with the user of the first user device 210a. In these or other embodiments, the process 260 may include one or more operations with respect to configuring the other user devices.

Further, modifications, additions, or omissions may be made to the system 200 and the processes described therewith without departing from the scope of the present disclosure. For example, the specific designations of operations with respect to the management system 204, the first user device 210a and the second user device 210b are given as examples and are not limiting. In some instances a same device or system may perform one or more operations as a user device and may perform one or more other operations as a management system. Further, in the present disclosure, a particular event management module 206 may be configured to direct different operations depending on which device or system it may be stored. Additionally or alternatively, a particular event management module 206 may be configured to direct different operations depending on a particular role that may be performed with respect to a particular device or system on which it may be stored.

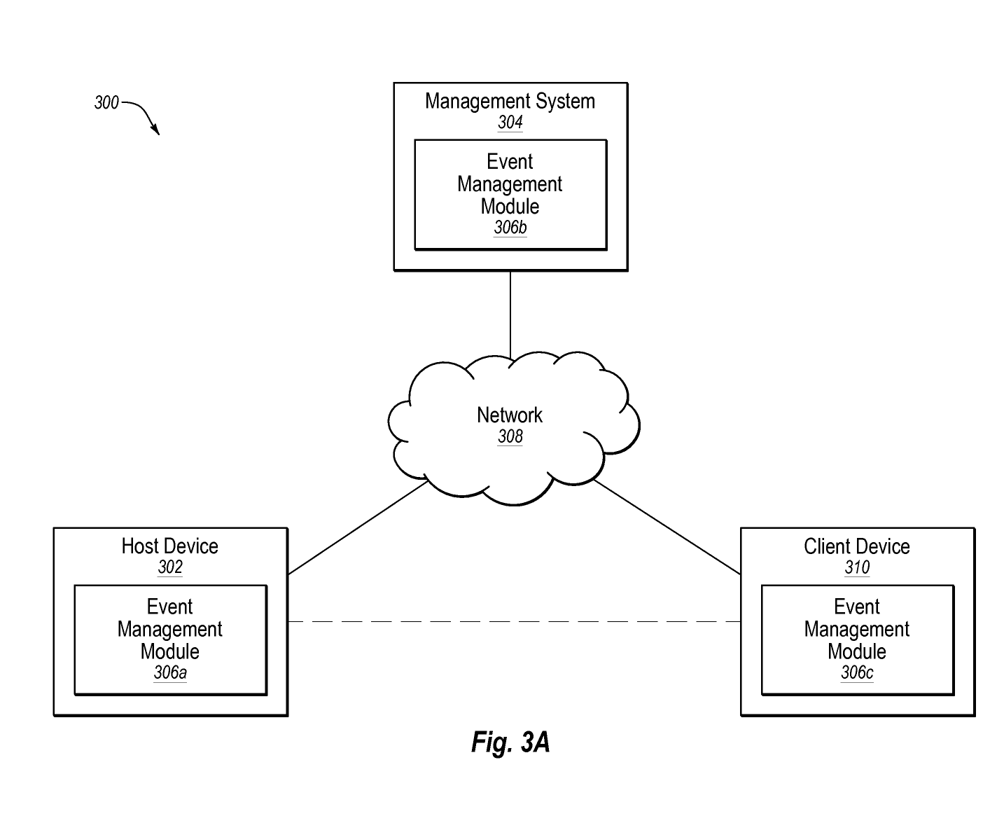

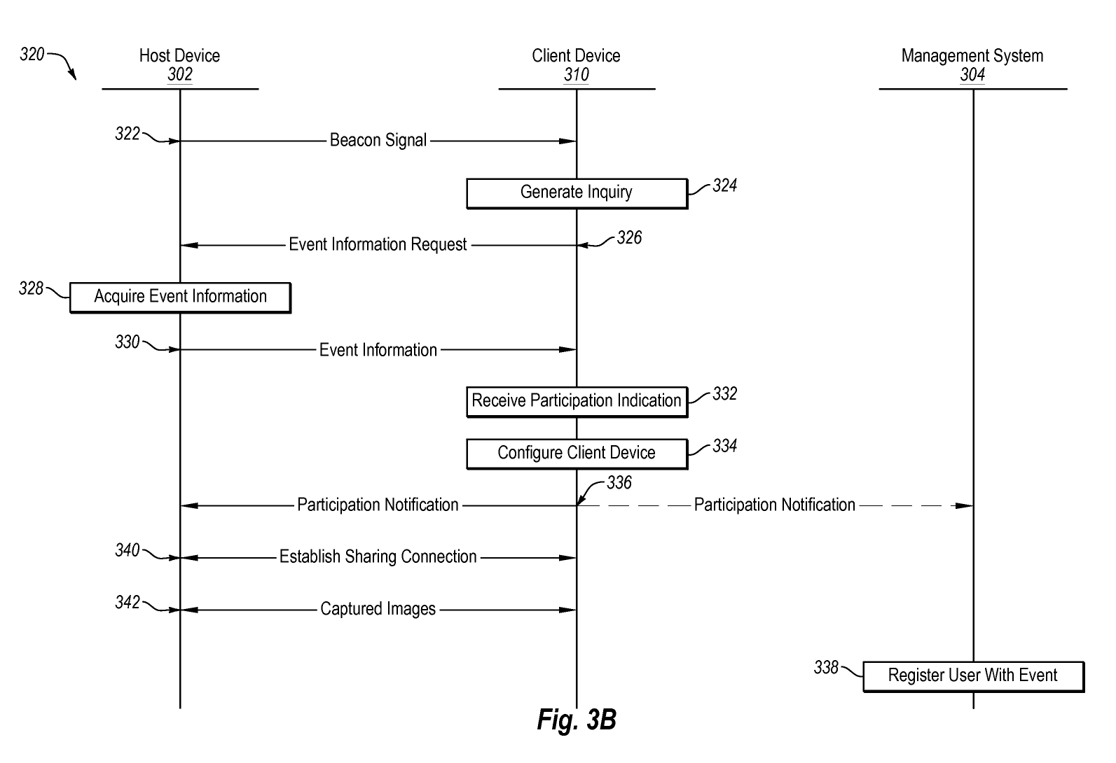

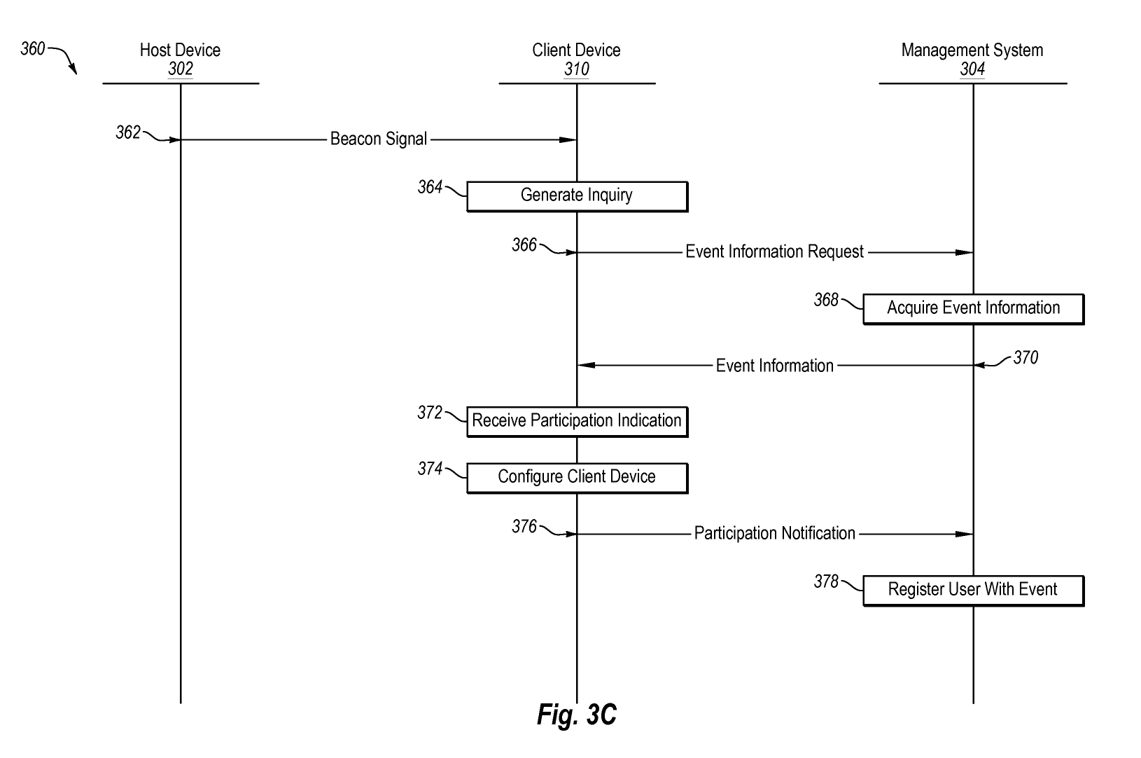

FIG. 3A illustrates a block diagram of an example system 300 configured to facilitate image sharing associated with an event, according to at least one embodiment of the present disclosure. The system 300 may include a host device 302, a management system 304, a network 308, and a client device 310.

The management system 304 may be analogous to the management system 104 of FIGS. 1A and 1B. Further, the network 308 may be analogous to the network 108 described with respect to FIG. 1A.

The host device 302 and the client device 310 may include any electronic device that may be configured to perform information processing. For example, the host device 302 or the client device 310 may include a mobile phone, a tablet computer, a desktop computer, a laptop computer, a camera, a personal digital assistant (PDA), a smartphone, a music player, a video player, etc. In some embodiments, users of the host device 302 and the client device 310 may include invitees, attendees, organizers, or image-sharing hosts of an event. In some embodiments, the host device 302 may include a sharing-host device (e.g., the sharing-host device 102 of FIGS. 1A and 1B) or a user device (e.g., the user devices 210 of FIGS. 2A-2D). Additionally or alternatively, the client device 310 may include a sharing-host device (e.g., the sharing-host device 102 of FIGS. 1A and 1B) or a user device (e.g., the user devices 210 of FIGS. 2A-2D)

In some embodiments, the host device 302 and the client device 310 may be configured to perform wireless communications with each other. For example, in some embodiments, the host device 302 and the client device 310 may be configured to perform one or more wireless communications with each other using a Bluetooth® communication protocol, an LTE device-to-device protocol, or any other protocol that may allow for device-to-device communication.

In some embodiments, the host device 302 may include an event management module 306a, the management system 304 may include an event management module 306b, and the client device 310 may include an event management module 306c. The event management modules 306 may include analogous or similar structures as those described with respect to the event management modules 106 described with respect to FIG. 1A. In some embodiments, the event management modules 306 may be configured to direct operations of their respective devices or systems such that their respective users may participate in image sharing with respect to an event.

FIG. 3B illustrates an example process 320 configured to facilitate image sharing with respect to an event, according to at least one embodiment described in the present disclosure. In some embodiments, one or more operations of the process 320 may be directed by one or more event management modules (e.g., one or more event management modules 306).

In the present example, the process 320 is described with respect to operations that may be performed by the host device 302, the management system 304, and the client device 310. One or more of such operations that may be described as being performed by the host device 302, the management system 304, or the client device 310 may be directed by the event management modules 306a, 306b, or 306c, respectively.

Although illustrated and described with respect to a particular sequence, the operations described with respect to the process 320 may be performed in a different order, in some embodiments. Additionally, one or more operations may be added to or removed from each operation described. In the present example, the process 320 describes operations that may be performed after an event has been registered, such as described with respect to the process 150 of FIG. 1B.

The process 320 may include an operation 322 at which the host device 302 may be configured to communicate a wireless beacon signal (“beacon signal”). In some embodiments, the beacon signal may be received by the client device 310. Additionally or alternatively, the beacon signal may be communicated based on any suitable wireless protocol such as the Bluetooth® protocol.

The beacon signal may include event information with respect to a registered event. In some embodiments, the information included in the beacon signal may include a unique identifier of the event. In these or other embodiments, the information included in the beacon signal may include other event information such as an event time, an event location, an event date, an event tag, an event organizer identifier, a sharing-host identifier, etc.

In some embodiments, such as when the beacon signal includes little information about the event (e.g., when the beacon signal includes only an event identifier), the client device 310 may be configured to generate an event inquiry at an operation 324. The event inquiry may include an inquiry for additional information regarding the event. For example, the event inquiry may include an inquiry for event information such as the event location, the event time, the event date, the sharing-host associated with the event, the event organizer, etc.

In some embodiments, the process 320 may include an operation 326. At the operation 326, the client device 310 may communicate an event information request to the host device 302. In some embodiments, the event information request may include the event inquiry for additional event information. In these or other embodiments, the event information request may include the event identifier included in the beacon signal. In some embodiments, the client device 310 may communicate the event information request via a wireless connection with the host device 302, such as via a Bluetooth® connection between the client device 310 and the host device 302.

In these or other embodiments, the process 320 may include an operation 328, at which the host device 302 may acquire event information. In some embodiments, the host device 302 may be configured to acquire the event information in response to receiving the event information request. Additionally or alternatively, the host device 302 may be configured to acquire the event information based on the event identifier that may be included in the event information request.

For example, in some embodiments, the host device 302 may compare the event identifier included in the event information request with one or more event identifiers stored thereon. The host device 302 may then acquire event information that may correspond to and that may be stored with respect to the matching event identifier.

In some embodiments, the process 320 may include an operation 330. At the operation 330, the host device 302 may communicate the event information to the client device 310. In some embodiments, the host device 302 may communicate the event information to the client device 310 in response to acquiring the event information in response to receiving the event information request. In some embodiments, the host device 302 may communicate the event information request via the wireless connection with the client device 310, such as via a Bluetooth® connection between the client device 310 and the host device 302.

In some embodiments, one or more of the operations 324, 326, 328, and 330 may be omitted from the process 320. For example, in some embodiments, the event information, including an invitation to participate in image sharing, may be included in the beacon signal that may be received by the client device 310. Accordingly, in these or other instances, the operations 324, 326, 328, and 330 may be omitted because the client device 310 may have already acquired the event information from the beacon signal.

At an operation 332 of the process 320, the client device 310 may receive an indication from a user of the client device 310 that may indicate whether or not the user accepts or declines to participate in image sharing with respect to the event associated with the beacon signal. The participation indication may also include an indication of a degree of participation in some embodiments. The operation 332 may be analogous to the operation 224 of the process 220 of FIG. 2B.

In some embodiments, the process 320 may include an operation 334. At the operation 334, the client device 310 may be configured to participate in image sharing with respect to the event. The operation 334 may include one more of the operations included in the operation 230 of the process 220 of FIG. 2B. Additionally or alternatively, in some embodiments, the client device 310 may be configured to perform operations as a host device at the operation 334. For example, the client device 310 may be configured to communicate a beacon signal that corresponds to the event. The beacon signal may be received by one or more other client devices. Additionally or alternatively, the client device 310 may be configured to perform any one of the operations described with respect to the host device 302 at the operation 334.

In some embodiments, the process 320 may include an operation 336. At the operation 336, the client device 310 may communicate (e.g., via the wireless connection) a participation notification to the host device 302. In these or other embodiments, the client device 310 may communicate (e.g., via the network 308) the participation notification to the management system 304. The participation notification that may be communicated to the management system 304 may include event information (e.g., the event identifier) and user information (e.g., a username with respect to the data management service) of the user of the client device 310.

In some embodiments, the process 320 may include an operation 338. At the operation 338, the management system 304 may register the user of the client device 310 with the event and the corresponding image sharing. In these or other embodiments, the management system 304 may register the user of the client device 310 with the event based on the event information and the user information. The operation 338 may be analogous to the operation 228 of the process 220 of FIG. 2B.

Additionally or alternatively, in some embodiments, the process 320 may include an operation 340. At the operation 340, the host device 302 and the client device 310 may establish an image-sharing connection. For example, the host device 302 and the client device 310 may establish a Bluetooth® connection over which the host device 302 and the client device 310 may share images.

In some embodiments, the image-sharing connection may be established in response to the user of the client device 310 indicating participation in image sharing. Additionally or alternatively, the image sharing connection may be established in response to a determination that the event indicated by the beacon signal is currently in progress.

In these or other embodiments, the process 320 may include an operation 342. At the operation 342, the host device 302 and the client device 310 may share images that may be captured during the event associated with the beacon signal. In some embodiments, the images may be shared via the image-sharing connection.

In these or other embodiments, the images may be shared between the host device 302 and the client device 310 based on one or more of the following: the participation indication communicated at the operation 336, the event associated with the beacon signal currently being in progress, and metadata included in the captured images.

For example, in some embodiments, the client device 310 may be configured to identify images that may be captured by the client device 310 during the event indicated by the beacon signal. The client device 310 may be configured to determine whether or not images are captured during the event based on event time information, event date information, event location information, a current time, a current date and/or a current location of the client device 310.

In particular, in some embodiments, the event management module 306c may be configured to acquire location information of the client device 310. Additionally or alternatively, the event management module 306c may also be configured to acquire current date and time information (e.g., from one or more other applications that may be included on the client device 310). The event management module 306c may be configured to compare one or more of the location information, the date information, and the time information with event location information, event date information, and/or event time information that may be included in the event information associated with the particular event. Additionally or alternatively, the event management module 306c may be configured to determine whether or not the client device 310 is at the particular event based on the comparison.

In some embodiments, the client device 310 may include an event tag that corresponds to the event in the metadata that corresponds to images captured during the event indicated by the beacon signal. The client device 310 may be configured to communicate to the host device 302 images that may be identified as being captured during the event indicated in the beacon signal. The host device 302 may be configured to perform similar or analogous operations to determine which images to communicate to the client device 310.

In some embodiments, the images may be shared between the host device 302 and the client device 310 during the event and in response to the images being captured. For example, the host device 302 may capture a particular image during the event, may then shortly determine that the particular image was captured during the event, and may shortly thereafter communicate the particular image to the client device 310. In these or other embodiments, the images may be shared after the event has ended.

In some embodiments, captured images may be shared as preview images. For example, the host device 302 may communicate a thumbnail of a particular image to the client device 310 instead of a larger image file of the particular image. In these or other embodiments, the client device 310 may be configured to request the larger image file from the host device 302 in response to a user command. The operations between the client device 310 and the host device 302 may be switched also.

In some embodiments, the sharing of the images using previews of the images may not use as much bandwidth over the image-sharing connection than if relatively larger image files of every image were communicated between the host device 302 and the client device 310. Additionally, the sharing of images based on previews may allow for users to select particular images of interest to the users for inclusion with their own set of images instead of automatically receiving all images that may captured during an event. In some embodiments, the sharing of the images using previews may be based on a bandwidth of the image-sharing connection, a connectivity strength of the image sharing connection, a current usage of bandwidth of the image sharing connection, a participation degree preference of a first user of the host device 302, a participation degree preference of a second user of the client device 310, or any combination thereof.

Additionally or alternatively, the sharing of images between the host device 302 and the client device 310 may also be based on one or more other participation degree preferences of the first user and/or of the second user. For example, the first user may have a first participation degree preference in which images captured by the host device 302 may be shared with other devices and in which images captured by other devices may be shared with the host device 302. In this particular example, the second user may have a second participation degree preference in which images captured by the client device 310 may not be shared with other devices and in which images captured by other devices may be shared with the client device 310. As such, in this example, the host device 302 may share images with the client device 310, but the client device 310 may not share images with the host device 302.

Additionally or alternatively, the sharing of images between the host device 302 and the client device 310 may be automatic or may be in response to an indication of sharing one or more particular images as directed by the first user or the second user. In these or other embodiments, the host device 302 and the client device 310 may be configured to participate in automatic sharing or directed sharing based on the first participation degree preference and the second participation degree preference, respectively.

Therefore, the process 320 may be configured to facilitate image sharing with respect to an event. Modifications, additions, or omissions may be made to the process 320 without departing from the scope of the present disclosure. For example, in some embodiments, the order and/or location as to where operations may be performed may vary. Additionally, in some embodiments, the process 320 may also include one or more operations analogous to operation 232 of the process 220 of FIG. 2B in which a user participation notification may be communicated to one or more other devices associated with the user of the client device 310. In these or other embodiments, the process 320 may include one or more operations with respect to configuring the other devices.

FIG. 3C illustrates another example process 360 configured to facilitate image sharing with respect to an event, according to at least one embodiment described in the present disclosure. In some embodiments, one or more operations of the process 360 may be directed by one or more event management modules (e.g., one or more event management modules 306).

In the present example, the process 360 is described with respect to operations that may be performed by the host device 302, the management system 304, and the client device 310. One or more of such operations that may be described as being performed by the host device 302, the management system 304, or the client device 310 may be directed by the event management modules 306a, 306b, or 306c, respectively.

Although illustrated and described with respect to a particular sequence, the operations described with respect to the process 360 may be performed in a different order, in some embodiments. Additionally, one or more operations may be added to or removed from each operation described. In the present example, the process 360 describes operations that may be performed after an event has been registered, such as described with respect to the process 150 of FIG. 1B.

The process 360 may include an operation 322 at which the host device 302 may be configured to communicate a wireless beacon signal (“beacon signal”). In some embodiments, the beacon signal may be received by the client device 310. The beacon signal and the communication thereof may be analogous to that described with respect to the operation 322 of the process 320 of FIG. 3B.

In some embodiments, such as when the beacon signal includes little information about the event (e.g., when the beacon signal includes only an event identifier), the client device 310 may be configured to generate an event inquiry at an operation 324. The generation of the event inquiry may be analogous to that described with respect to the operation 324 of the process 320 of FIG. 3B.

In some embodiments, the process 360 may include an operation 366. At the operation 366, the client device 310 may communicate (e.g., via the network 308) an event information request to the management system 304. In some embodiments, the event information request may include the event inquiry for additional event information.

In some embodiments, the beacon signal may include an indication of the event (e.g., a unique event identifier) and a web address (e.g., a Uniform Resource Locator (URL) Address) but not additional event information. Additionally, the web address may direct to a connection with the management system 304. In these or other embodiments, the client device 310 may communicate the event information request to the management system 304 based on the event identifier included in the beacon signal and may be directed to the management system 304 based on the web address that may be included in the beacon signal.

In these or other embodiments, the process 360 may include an operation 368, at which the management system 304 may acquire event information. In some embodiments, the management system 304 may be configured to acquire the event information in response to receiving the event information request. Additionally or alternatively, the management system 304 may be configured to acquire the event information based on the event identifier that may be included in the event information request. The management system 304 may be configured to acquire the event information based on one or more operations that may be similar or analogous to the operation 246 of the process 240 of FIG. 2C.

In some embodiments, the process 360 may include an operation 370. At the operation 370, the management system 304 may communicate (e.g., via the network 308) the event information to the client device 310. In some embodiments, the management system 304 may communicate the event information to the client device 310 in response to acquiring the event information in response to receiving the event information request.

In some embodiments, one or more of the operations 364, 366, 368, and 370 may be omitted from the process 360. For example, in some embodiments, the event information, including an invitation to participate in image sharing, may be included in the beacon signal that may be received by the client device 310. Accordingly, in these or other instances, the operations 364, 366, 368, and 370 may be omitted because the client device 310 may have already acquired the event information from the beacon signal.

At an operation 372 of the process 360, the client device 310 may receive an indication from a user of the client device 310 that may indicate whether or not the user accepts or declines to participate in image sharing with respect to the event associated with the beacon signal. The participation notification may also include an indication of a degree of participation in some embodiments. The operation 372 may be analogous to the operation 224 of the process 220 of FIG. 2B.

In some embodiments, the process 360 may include an operation 374. At the operation 374, the client device 310 may be configured to participate in image sharing with respect to the event. The operation 374 may include one more of the operations included in the operation 230 of the process 220 of FIG. 2B or included in the operation 334 of the process 320 of FIG. 3B.

In some embodiments, the process 360 may include an operation 376. At the operation 376, the client device 310 may communicate (e.g., via the network 308) a participation notification to the management system 304. The participation notification that may be communicated to the management system 304 may include event information (e.g., the event identifier) and user information (e.g., a username with respect to the data management service) of the user of the client device 310.

In some embodiments, the process 360 may include an operation 378. At the operation 378, the management system 304 may register the user of the client device 310 with the event and the corresponding image sharing. In these or other embodiments, the management system 304 may register the user of the client device 310 with the event based on the event information and the user information. The operation 338 may be analogous to the operation 228 of the process 220 of FIG. 2B.

Therefore, the process 360 may be configured to facilitate image sharing with respect to an event. Modifications, additions, or omissions may be made to the process 360 without departing from the scope of the present disclosure. For example, in some embodiments, the order and/or location as to where operations may be performed may vary. Additionally, in some embodiments, the process 360 may also include one or more operations analogous to operation 232 of the process 220 of FIG. 2B in which a user participation notification may be communicated to one or more other devices associated with the user of the client device 310. In these or other embodiments, the process 360 may include one or more operations with respect to configuring the other devices.

Further, modifications, additions, or omissions may be made to the system 300 and the processes described therewith without departing from the scope of the present disclosure. For example, the specific designations of operations with respect to the host device 302, the management system 304, and the client device 310 are given as examples and are not limiting. In some instances a same device or system may perform one or more operations as a user device and may perform one or more other operations as a management system. Further, in the present disclosure, a particular event management module 306 may be configured to direct different operations depending on which device or system it may be stored. Additionally or alternatively, a particular event management module 306 may be configured to direct different operations depending on a particular role that may be performed with respect to a particular device or system on which it may be stored.

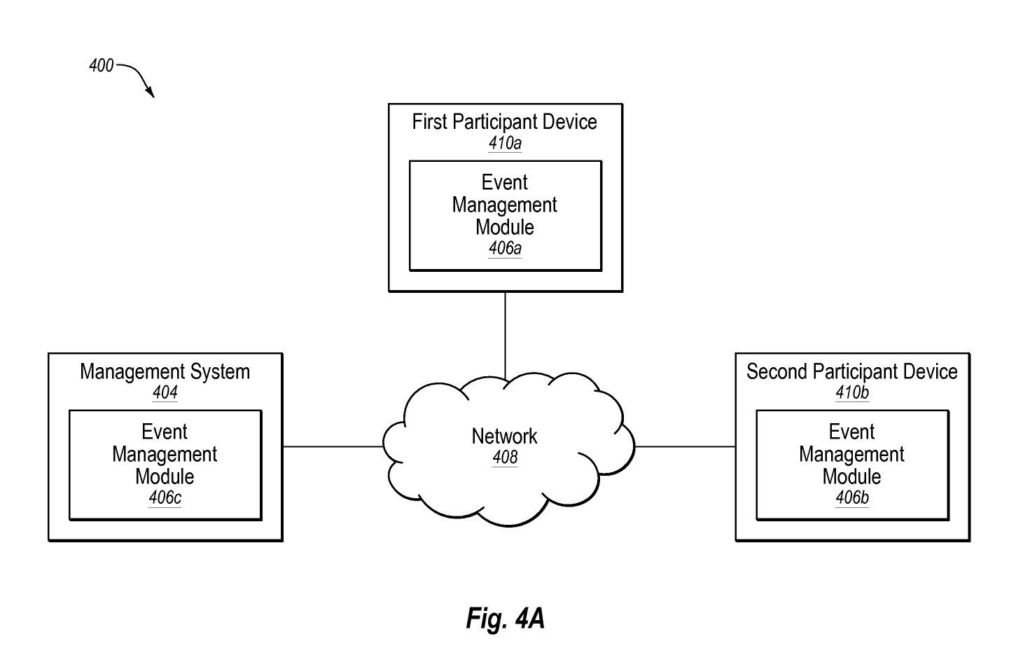

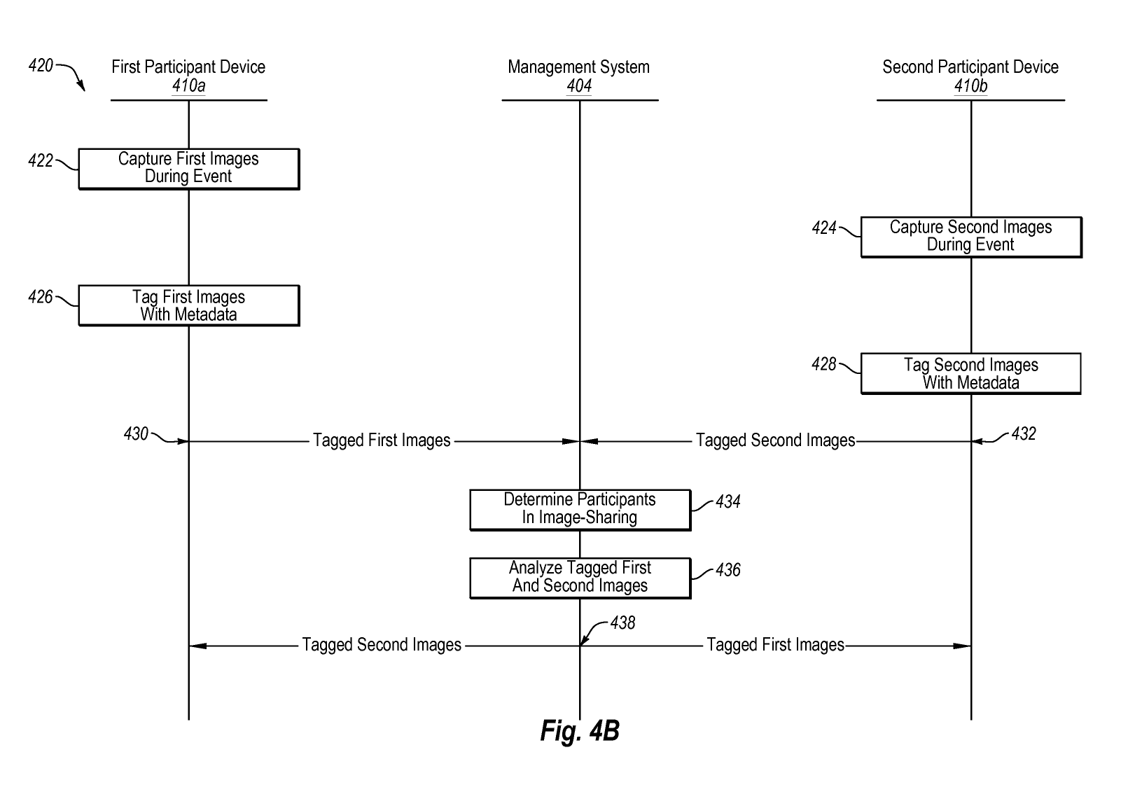

FIG. 4A illustrates a block diagram of an example system 400 configured to perform image sharing associated with an event, according to at least one embodiment of the present disclosure. The system 400 may include a management system 404, a network 408, a first participant device 410a, and a second participant device 410b.

The management system 404 may be analogous to the management system 104 of FIGS. 1A and 1B. Further, the network 408 may be analogous to the network 108 described with respect to FIG. 1A.

The participant devices 410 may include any electronic device that may be configured to perform information processing. For example, the participant devices 410 may include a mobile phone, a tablet computer, a desktop computer, a laptop computer, a camera, a personal digital assistant (PDA), a smartphone, a music player, a video player, etc. In some embodiments, users of the participant devices 410 may include invitees, attendees, organizers, or image-sharing hosts of an event. In some embodiments, the participant devices may include a sharing-host device (e.g., the sharing-host device 102 of FIGS. 1A and 1B), a user device (e.g., the user devices 210 of FIGS. 2A-2D), a host device (e.g., the host device 302 of FIGS. 3A-3C), or a client device (e.g., the client device 310 of FIGS. 3A-3C).

In some embodiments, the first participant device 410a may include an event management module 406a, the second participant device may include an event management module 406b, and the management system 404 may include an event management module 406c. The event management modules 406 may be analogous to the event management modules 106 described with respect to FIG. 1A. In some embodiments, the event management modules 406 may be configured to direct operations of their respective devices or systems such that their respective users may participate in image sharing with respect to an event.

FIG. 4B illustrates an example process 420 configured to share images with respect to an event, according to at least one embodiment described in the present disclosure. In some embodiments, one or more operations of the process 420 may be directed by one or more event management modules (e.g., one or more event management modules 406).

In the present example, the process 420 is described with respect to operations that may be performed by the first participant device 410a, the second participant device 410b, and the management system 404. One or more of such operations that may be described as being performed by the first participant device 410a, the second participant device 410b, or the management system 404 may be directed by the event management modules 406a, 406b, or 406c, respectively.

Although illustrated and described with respect to a particular sequence, the operations described with respect to the process 420 may be performed in a different order, in some embodiments. Additionally, one or more operations may be added to or removed from each operation described. In the present example, the process 420 may include operations that may be performed after an event has been registered, such as described with respect to the process 150 of FIG. 1B.

Additionally, the process 420 may include operations that may be performed after a first participant of the first participant device 410a and a participant user of the second participant device 410b have been registered as participants in image sharing with respect to a particular event. The first and second participant may include an event organizer, an image-sharing host, an event invitee, and/or an event attendee. Further, the process 420 may include operations that may occur after the first participant device 410a and/or the second participant device 410b have been configured to participate in image sharing.

The process 420 may include an operation 422 at which the first participant device 410a may capture one or more first images during the particular event. The process 420 may also include an operation 424 at which the second participant device 410b may capture one or more second images during the particular event.

The process 420 may include an operation 426. At the operation 426, the first participant device 410a may tag the first images (e.g., include in first metadata of the first images) that may be captured during the particular event. In some embodiments, the first images may be tagged with time information, location information, and/or date information that may indicate a time, date, and/or location of capture of the first images. Additionally or alternatively, the first participant device 410a may be configured to tag the first images with a particular event tag that may correspond to the particular event. In these or other embodiments, the first participant device 410a may tag the first images with geolocation data, audio data, voice tag data, motion data, biological data, temperature data, a time stamp, a date stamp, user tag data, barometric pressure data, people data, and/or camera orientation data audio data, voice tag data, motion data, biological data, temperature data, a time stamp, a date stamp, user tag data, barometric pressure data, people data, and/or camera orientation data.

In some embodiments, the first participant device 410a may be configured to tag the first images (e.g., include in first metadata of the first images) with the particular event tag in response to a determination that the first images were captured at the particular event. In these or other embodiments, the first participant device 410a may be configured to determine that the first images were captured at the particular event based on current time, date, and/or location information and based on event information associated with the particular event that may have been previously received by the first participant device 410a. In some embodiments, the first participant device 410a may be configured to determine that the first images were captured at the particular event based on one or more operations described previously with respect to the operation 342 of the process 320 of FIG. 3B. Additionally or alternatively, the first participant device 410a may be configured to determine that the first images were captured at the particular event based on linking of the image files as described below.

The process 420 may also include an operation 428. At the operation 428, the second participant device 410b may tag the second images (e.g., include in second metadata of the second images) that may be captured during the particular event. In some embodiments, the second images may be tagged with time information, location information, and/or date information that may indicate a time, date, and/or location of capture of the second images. Additionally or alternatively, the second participant device 410b may be configured to tag the second images with the particular event tag. In these or other embodiments, the second participant device 410b may tag the second images with geolocation data, audio data, voice tag data, motion data, biological data, temperature data, a time stamp, a date stamp, user tag data, barometric pressure data, people data, and/or camera orientation data audio data, voice tag data, motion data, biological data, temperature data, a time stamp, a date stamp, user tag data, barometric pressure data, people data, and/or camera orientation data

In some embodiments, the second participant device 410b may be configured to tag the second images (e.g., include in second metadata of the second images) with the particular event tag in response to a determination that the second images were captured during the particular event. In these or other embodiments, the second participant device 410b may be configured to determine that the second images were captured during the particular event based on current time, date, and/or location information and based on event information associated with the particular event that may have been previously received by the second participant device 410b. In some embodiments, the second participant device 410b may be configured to determine that the first images were captured at the particular event based on one or more operations described previously with respect to the operation 342 of the process 320 of FIG. 3B. Additionally or alternatively, the second participant device 410b may be configured to determine that the first images were captured at the particular event based on linking of the image files as described below.

The process 420 may also include an operation 430 in some embodiments. At the operation 430, the first participant device 410a may communicate (e.g., via the network 408) the tagged first images to the management system 404. In some embodiments, the first participant device 410a may be configured to communicate the tagged first images based on a first participation degree preference of the first participant authorizing the sharing of the first images. In these or other embodiments, the first participant device 410a may be configured to automatically communicate the tagged first images or to communicate the tagged first images based on a command received from the first participant to do so.

The process 420 may also include an operation 432 in some embodiments. At the operation 432, the second participant device 410b may communicate (e.g., via the network 408) the tagged second images to the management system 404. In some embodiments, the second participant device 410b may be configured to communicate the tagged second images based on a second participation degree preference of the second participant authorizing the sharing of the first images. In these or other embodiments, the second participant device 410b may be configured to automatically communicate the tagged second images or to communicate the tagged second images based on a command received from the second participant to do so.

In some embodiments, the process 420 may include an operation 434. At the operation 434, the management system 404 may determine that the first participant and the second participant are participants in image sharing with respect to the particular event. For example, in some embodiments, the management system 404 may determine that the first participant and the second participant are registered to participate in image sharing with respect to the particular event based on user registration information and event registration information that may be stored thereon.

Additionally or alternatively, the management system 404 may be configured to determine that the first participant and/or the second participant are participants in image sharing with respect to the particular event based on the particular event tag. For example, the tagged first images received from the first participant device 410a may include the particular event tag and may be received via a first account of the first participant. The first account may be held with respect to a data management system with which the management system 404 may be associated. As such, the management system 404 may be configured to determine that the first participant is a participant in image sharing with respect to the particular event based on the particular event tag and first account information associated with the first account.

In some embodiments, the process 420 may include an operation 436. At the operation 436, the management system 404 may analyze the first and second images to determine that they were captured during the particular event. In some embodiments, the management system 404 may analyze the first and second images in response to and based on determining that the first and second participants are participants in image sharing with respect to the particular event.

In some embodiments, the management system 404 may be configured to determine that the first and second images were captured during the particular event based on metadata of the first and second images. For example, in some embodiments, the first metadata of the first images and the second metadata of the second images may include the particular event tag. Based on the first metadata and the second metadata including the particular event tag, the management system 404 may determine that the first images and the second images were captured during the particular event.

Additionally or alternatively, the first metadata and the second metadata may include time, date, and/or location information that may indicate a time, a date, and/or a location of capture of the first images and of the second images. The management system 404 may be configured to compare the time, date, and/or location information of the first and second images with event time, event date, and/or event location information of the particular event. Based on the comparison, the management system 404 may be configured to determine that the first and second images were captured during the particular event. In some embodiments, the management system 404 may be configured to determine that one or more of the first images and/or that one or more of the second images were captured at the particular event based on one or more operations similar or analogous to those described previously with respect to the operation 342 of the process 320 of FIG. 3B. Additionally or alternatively, the management system 404 may be configured to determine that the first and second images were captured during the particular event based on linking of the first and second images as described below.

Additionally or alternatively, the management system 404 may be configured to determine that one or more of the first images or one or more of the second images were captured during the event based on the participation indication and based the image capture information. For example, in some embodiments, the image capture information may indicate a time and date of capture of the image, but not a location. However, based on an indication of participation in the image sharing by the first and second participants, based on reception of the first and second images by the first and second participants, respectively, and based on time and date information associated with the first and second images, the management system 404 may infer that first and second images were captured during the event even if location information is not included therewith, in some embodiments.

In some embodiments, the process 420 may include an operation 438. At the operation 438, the tagged second images (which may be determined as being captured during the particular event) may be shared with the first participant device 410a. Additionally or alternatively, at the operation 438, the tagged first images (which may be determined as being captured during the particular event) may be shared with the second participant device 410b. In some embodiments, the tagged second images may be shared with the first participant device 410a based on the first participation degree preference of the first participant. Additionally or alternatively, the tagged first images may be shared with the second participant device 410b based on the second participation degree preference of the second participant. In these or other embodiments, the tagged first images and the tagged second images may be automatically shared. Additionally or alternatively, the tagged first images and the tagged second images may be initially shared as preview images with the second participant and the first participant, respectively. Larger images may be shared in response to selections by the first participant or the second participant. In the present disclosure, the sharing of images may include communicating between participant devices any suitable image file that may include a representation of an image.

In some embodiments, the sharing of the images using previews may be based on a bandwidth of a connection (e.g., uplink or downlink) between a respective participant device 410 and the management system 404, a connectivity strength of the corresponding connection, a current usage of bandwidth of the corresponding connection, the first participation degree preference, the second participation degree preference, or any combination thereof.

Therefore, the process 420 may be configured to share images with respect to an event. Modifications, additions, or omissions may be made to the process 420 without departing from the scope of the present disclosure. For example, in some embodiments, the order and/or location as to where operations may be performed may vary. For example, in some embodiments, the first images may be captured a first first-participant device of the first participant and may be communicated to the management system 404 by a second first-participant device of the first participant. Additionally or alternatively, the tagged second images may be communicated to multiple first participant devices of the first participant. Similar variations may apply with respect to second participant devices.

Further, modifications, additions, or omissions may be made to the system 400 and the processes described therewith without departing from the scope of the present disclosure. For example, the specific designations of operations with respect to the first participant device 410a, the second participant device 410b, and the management system 404 are given as examples and are not limiting. In some instances a same device or system may perform one or more operations as a user device and may perform one or more other operations as a management system.

Further, in the present disclosure, a particular event management module 406 may be configured to direct different operations depending on which device or system it may be stored. Additionally or alternatively, a particular event management module 406 may be configured to direct different operations depending on a particular role that may be performed with respect to a particular device or system on which it may be stored.

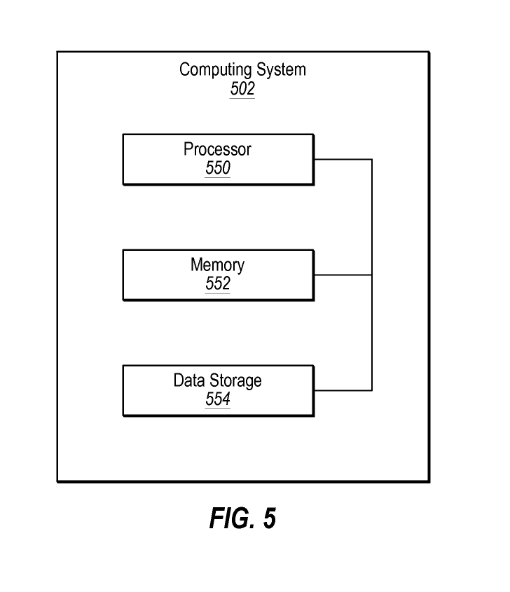

FIG. 5 illustrates a block diagram of an example computing system 502, according to at least one embodiment of the present disclosure. The computing system 502 may be included in any one of the sharing-host device 102 of FIGS. 1A and 1B, the management systems 104, 204, 304, and 404 of FIGS. 1A-1B, 2A-2D, 3A-3C, and 4A-4B, respectively, the user devices 210 of FIGS. 2A-2D, the host device 302 of FIGS. 3A-3C, the client device 310 of FIGS. 3A-3C, and the participant devices 410 of FIGS. 4A-4B. The computing system 502 may include a processor 550, a memory 552, and a data storage 554. The processor 550, the memory 552, and the data storage 554 may be communicatively coupled.

In general, the processor 550 may include any suitable special-purpose or general-purpose computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to perform, individually or collectively, any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may be configured to fetch program instructions from the data storage 554 and load the program instructions in the memory 552. After the program instructions are loaded into memory 552, the processor 550 may execute the program instructions.

For example, in some embodiments, an event management module may be included in the data storage 554 as program instructions. The processor 550 may fetch the program instructions of the event management module from the data storage 554 and may load the program instructions of the event management module into the memory 552. Alternatively, the data storage 554 may each include one or more storage agents that may be configured to manage the storage of data on the data storage 554. The storage agent may fetch program instructions of the event management module from the data storage 554 and may load the program instructions of the event management module into the memory 552. After the program instructions of the event management module are loaded into the memory 552, the processor 550 may execute the program instructions such that the computing system 502 may implement the operations associated with the event management module as directed by the instructions.

The memory 552 and the data storage 554 may include computer-readable storage media for carrying or having computer-executable instructions or data structures stored thereon. Such computer-readable storage media may include any available media that may be accessed by a general-purpose or special-purpose computer, such as the processor 550 or a storage agent. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media.

Modifications, additions, or omissions may be made to the computing system 502 without departing from the scope of the present disclosure. For example, in some embodiments, the computing system 502 may include any number of other components that may not be explicitly illustrated or described.

In the present disclosure, different processes are described with respect to devices or systems with different titles or names given. However, the distinctions are made to aid in explanation and not to limit specific devices or systems to specific operations. In some instances, a same device or system may perform operations that are described in the present disclosure with respect to different devices or systems. Additionally, one or more operations from one or more of the processes described in the present disclosure may be included with one or more other processes described in the present disclosure without departing from the scope of the present disclosure.

As indicated above, the embodiments described in the present disclosure may include the use of a special purpose or general purpose computer (e.g., the processor 550 of FIG. 5) including various computer hardware or software modules, as discussed in greater detail below. Further, as indicated above, embodiments described in the present disclosure may be implemented using computer-readable media (e.g., the memory 552 of FIG. 5) for carrying or having computer-executable instructions or data structures stored thereon.

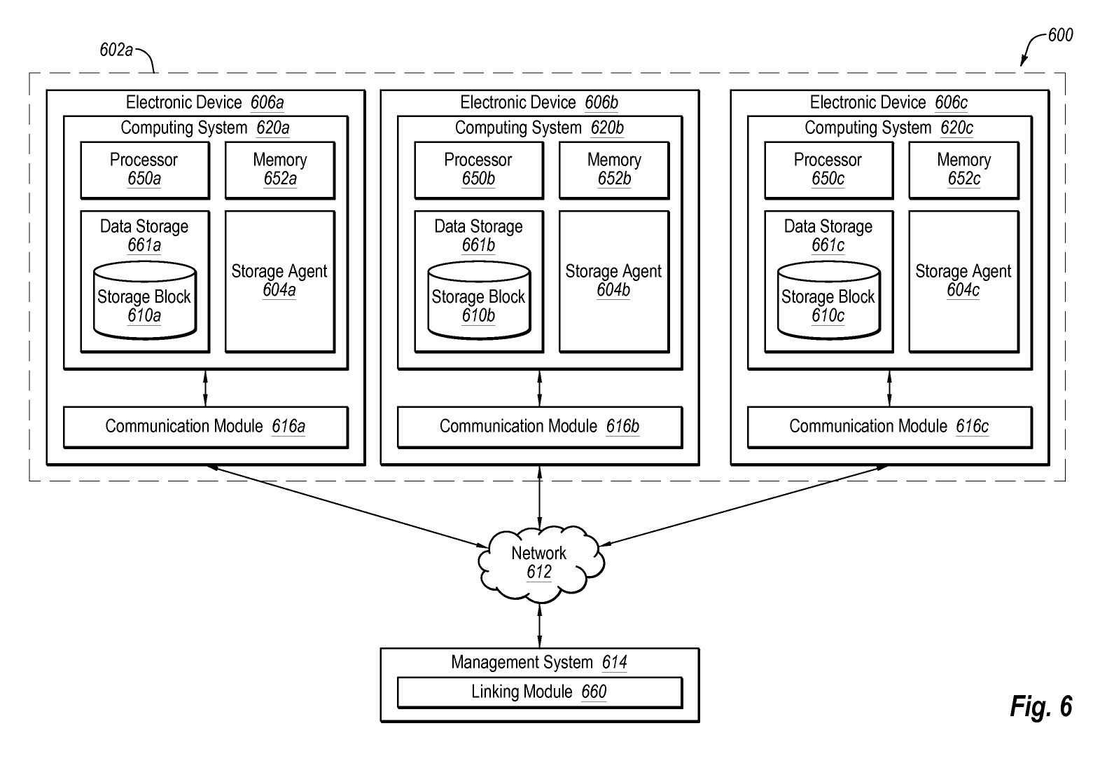

FIG. 6 illustrates a block diagram of an example system 600 configured to images based on the images being captured during the same event, according to at least one embodiment of the present disclosure. The system 600 of the illustrated embodiment is depicted as including electronic devices 606a-606c (also referred to as “devices” 606 Although the system 600 is illustrated as including three different devices 606 and data storage 661 and storage blocks 610, associated therewith, the system 600 may include any number of devices 606.

The devices 606 may include any electronic device that may be configured to store data or maintain the storage of data. For example, the devices 606 may include any one of a cloud storage server, a web-services server (e.g., a social network server), a mobile phone, a tablet computer, a desktop computer, a laptop computer, a camera, a personal digital assistant (PDA), a smartphone, a music player, a video player, an external hard drive, etc. In some embodiments, one or more of the devices 606 may include a sharing-host device, a user device, a host device, a client device, or a participant device, such as those described above.

In some embodiments, the devices 606 may each include a computing system 620, which may each include a processor 650, memory 652, data storage 661 and a storage block 610. The processors 650, the memories 652, and the data storages 660 may be analogous to the processor 550, the memory 552, and the data storage 554, respectively, described with respect to FIG. 5. Additionally, the computing systems 620 may each include one or more storage agents 604 that may be configured to manage the storage of data on the data storage 661. By way of example, in the illustrated embodiment, the device 606a may include a computing system 620a that includes a storage agent 604a, a processor 650a, memory 652a, and a data storage 661a that may include a storage block 610a; the device 606b may include a computing system 620b that includes a storage agent 604b, a processor 650b, memory 652b, and a data storage 661b that may include a storage block 610b; and the device 606c may include a computing system 620c that includes a storage agent 604c, a processor 650c, memory 652c, and a data storage 661c that may include a storage block 610c.

The data storage 661 may also include storage blocks 610 that may include any suitable computer-readable medium configured to store data. The storage blocks 610 may store data that may be substantially the same across different storage blocks 610 and may also store data that may only be found on the particular storage block 610. Although each device 606 is depicted as including a single storage block 610, the devices 606 may include any number of storage blocks 610 of any suitable type of computer-readable medium. For example, a particular device 606 may include a first storage block 610 that is a hard disk drive and a second storage block 610 that is a flash disk drive. Further, a particular storage block 610 may include more than one type of computer-readable medium. For example, a storage block 610 may include a hard disk drive and a flash drive. Additionally, the same storage block 610 may be associated with more than one device 606 depending on different implementations and configurations. For example, a storage block 610 may be a Universal Serial Bus (USB) storage device or a Secure Digital (SD) card that may be connected to different devices 606 at different times.

In some embodiments, the storage blocks 610 may include image files stored thereon. The image files may include still image files (e.g., photographs) or video image files that may correspond to images that have been captured. The storage blocks 610 may also include metadata associated with the image files stored thereon. The metadata may include geolocation data, audio data, voice tag data, motion data, biological data, temperature data, a time stamp, a date stamp, user tag data, barometric pressure data, people data, and/or camera orientation data. As described in further detail below, the system 600 may be configured to link and/or share images associated with the same event based on the metadata associated with corresponding image files.

The devices 606 may each include a communication module 616 that may allow for communication of data (e.g., image files) between the devices 606. For example, the device 606a may include a communication module 616a; the device 606b may include a communication module 616b; and the device 606c may include a communication module 616c.

The communication modules 616 may provide any suitable form of communication capability between the devices 606. By way of example and not limitation, the communication modules 616 may be configured to provide, via wired and/or wireless mechanisms, Internet connectivity, Local Area Network (LAN) connectivity, Wide Area Network (WAN) connectivity, Bluetooth connectivity, 3G connectivity, 4G connectivity, LTE connectivity, Wireless Fidelity (Wi-Fi) connectivity, Machine-to-Machine (M2M) connectivity, Device-to-Device (D2D) connectivity, any other suitable communication capability, or any suitable combination thereof.

In the illustrated embodiment, the communication modules 616 are depicted as providing connectivity between the devices 606 via a communication network 612 (referred to hereinafter as “network 612”). In some embodiments, the network 612 may include, either alone or in any suitable combination, the Internet, an Intranet, a local Wi-Fi network, a wireless LAN, a mobile network (e.g., a 3G, 4G, and/or LTE network), a LAN, a WAN, or any other suitable communication network. Although not expressly depicted in FIG. 6, in these and other embodiments, the communication modules 616 may provide direct connectivity between the devices 606.

The storage agents 604 may be configured to manage the storage of data on the storage blocks 610 of their respective devices 606. Specifically, the storage agents 604 may be configured to manage the image files stored on the storage blocks 610 of their respective devices 606 to facilitate the linking and/or sharing of corresponding images based on the images being associated with the same event as described in detail below. The storage agents 604 may also be configured to perform any number of other operations associated with the management of data stored on the storage blocks 610. In some embodiments, the storage agents 604 may be included with an event management module such as those described above.

The system 600 may include a management system 614. In some embodiments, the management system 614 may be analogous to the management system 104 of FIG. 1A. Additionally or alternatively, the management system 614 may include a computing system such as the computing system 502 of FIG. 5.

In some embodiments, the management system 614 may include a linking module 660. The linking module 660 may include code and routines configured to enable or cause a computing system to perform operations related to sharing or linking images that may be captured during an event. Additionally or alternatively, the linking module 660 may be implemented using hardware including a processor, a microprocessor (e.g., to perform or control performance of one or more operations), a field-programmable gate array (FPGA), or an application-specific integrated circuit (ASIC). In some other instances, the linking module 660 may be implemented using a combination of hardware and software. In the present disclosure, operations described as being performed by the linking module 660 may include operations that the linking module 660 may direct a corresponding system or device (e.g., the management system 614) to perform. In some embodiments, the linking module 660 may be included with an event management module, such as those described above.

In some embodiments, the linking module 660 may be configured to, analyze metadata of image files stored on the devices 606, determining which corresponding images are likely associated with the same event based on the metadata and linking the images that are determined to likely be associated with the same event.

The linking module 660 may have access to the image files stored on the devices 606 through any applicable mechanism or procedure. For example, in some embodiments, the devices 606 may include servers associated with a social media service such as Facebook® or Instagram® and the management system 614 may be used by the social media service to manage the accounts and data associated with the social media service. The linking module 660 may be configured to analyze the metadata of image files stored on the devices 606 that may be associated with different user accounts of the social media service. Based on the metadata, the linking module 660 may determine which corresponding images may likely be associated with the same event. The linking module 660 may then link images, including those associated with different user accounts, that are likely associated with the same event.

As another example, in some instances a group of people (e.g., a household, a family, etc.) may have a storage network and network service such as that described in U.S. patent application Ser. No. 14/137,654, filed on Dec. 20, 2013 and entitled STORAGE NETWORK DATA ALLOCATION, the contents of which are herein incorporated by reference in their entirety. In these instances, the management system 614 may be associated with a storage network manager configured to manage the storage network and may have access to the image files included in the storage network. The linking module 660 may be configured to analyze the metadata of image files stored on the devices 606 included in the storage network. Based on the metadata of the image files of the storage network, the linking module 660 may determine which image files may likely be associated with the same event. The linking module 660 may then link image files of the storage network that are likely associated with the same event.

In other embodiments, the linking module 660 may simply be installed on a particular device 606 and may manage the image files stored locally on the particular device 606. In these and other embodiments, the linking module 660 may also determine which image files are likely associated with the same event and may organize the image files accordingly.

In some embodiments, the image files that are linked according to an event may be shared with others who may have also attended the event or contributed image files associated with the event. For example, with respect to the social media example described above, image files of two Facebook® or Instagram® friends that are linked based on an event may be automatically shared between the friends' accounts by the linking module 660. Accordingly, the friends may have each other's image files associated with the event. In these or other embodiments, for social media applications, the linking module 660 may generate a social media page associated with the event and may include on the social media page the image files from one or more user accounts that are linked to the event. In some of these embodiments, users who contribute at least one of the image files associated with the event may have access to the social media page such that the user's may have access to more pictures associated with the event than those merely contributed by the user. Additionally or alternatively, the images may be shared in a manner as described above with respect to FIG. 4B.

As indicated above, the linking module 660 may link images to the same event based on the metadata of corresponding image files. For example, the metadata may include geolocation (e.g., global positioning system (GPS)) data. In some embodiments, the file linking module 660 may be configured to analyze geolocation data associated with image files to determine which image files are associated with pictures and/or video taken in the same general geographical area. In some embodiments, the linking module 660 may be configured to group images based on corresponding image files including image data captured within a specified distance of each other. For example, the linking module 660 may be configured to group images that were captured within 1,000 meters of each other based on an analysis of corresponding image data.

In some embodiments, the specified distance may vary depending on the actual locations associated with the images. For example, the linking module 660 may include information associated with landmarks, structures, areas of interest, etc. associated with certain GPS coordinates. By way of example, the linking module 660 may know the GPS coordinates of performance centers, stadiums, arenas, schools, amusement parks, city parks, state parks, national parks, etc. In these or other embodiments, the linking module 660 may analyze the geolocation data associated with corresponding image files and may determine the landmark, structure, areas of interest, etc. associated with where the associated images were taken. For example, the linking module 660 may determine that a certain number of image files include image data captured in a stadium or certain national park based on the geolocation data associated with the image files.

The linking module 660 may then set the specified distance for the grouping based on size of the landmark, structure, area of interest etc. For example, for images associated with a stadium, the specified distance may be set to include mainly the stadium and for images associated with a national park, the specified distance may be set to include mainly the national park, which may be significantly larger than that used for the stadium.

In these or other embodiments, instead of using a specified distance between the geolocations of images, the linking module 660 may be configured to determine the landmark, structure, areas of interest, etc. associated with where the associated images were captured. The linking module 660 may then link images that have geolocations within the same landmark, structure, areas of interest etc.

The linking module 660 may also group images with geolocations that are within a certain geographical area based on time and date. For example, the linking module 660 may group images associated with a similar geolocation as described above that also have a time and date that are within a certain amount of time. For example, the linking module 660 may be configured to group images with a similar geolocation that also have times and dates within three hours of each other.

By grouping images based on geolocation, times, and dates, the linking module 660 may determine that the images with similar geolocations, times, and dates are likely associated with the same event. The linking module 660 may thus link such images based on this determination such that images and corresponding image files that are likely associated with the same event may be organized and/or shared accordingly. In some embodiments, the images linked with an event may be organized according to time and date such that a timeline of the event may be generated.

The linking module 660 may also be configured to link images based on camera orientation data included in the metadata. For example, camera orientation data may include information regarding the tilt, pitch, and/or roll of a camera when capturing image data associated with the image files. The camera orientation data may also include the direction (e.g., north, south, east, west) in which the camera may be facing while capturing the image data. In some embodiments, at least some of the camera orientation data may be derived based on GPS data. In these or other embodiments, the camera orientation data may also be derived from motion data, which may indicate the orientation of the camera.

Based on the camera orientation data and the geolocation data of image files, the linking module 660 may be configured to determine whether the corresponding images are depicting substantially the same location but from different perspectives. In these or other embodiments, the linking module 660 may also compare timestamps of the image files to determine whether the corresponding images are depicting substantially the same location at approximately the same time. Accordingly, the linking module 660 may be configured to further link images based on whether or not the images are depicting substantially the same location and in some instances at the same time. Linking images based on the images depicting substantially the same location at substantially the same time may allow for the sharing of images having different perspectives of the same moment of an event, such as the scoring of a goal in a soccer game.

Based on the data of the image files themselves the linking module 660 may be configured to determine whether the corresponding images are depicting substantially the same thing but from different perspectives. In these or other embodiments, the linking module 660 may also compare the data of the image file itself to determine whether the corresponding images are depicting the same thing. These comparisons may be accomplished using image processing techniques including, but not limited to correlation and spectral analysis. Accordingly the linking module 660 may be configured to further link images based on whether or not the images are depicting substantially the same thing and in some instances at the same time. Linking images based on the images depicting substantially the same thing may allow for the sharing of images having different perspectives of the same thing such as a landmark or object. Linking images based on the images depicting substantially the same thing at substantially the same time may allow for the sharing of images having different perspectives of the same moment of an event, such as the scoring of a goal in a soccer game.

In these or other embodiments, the linking module 660 may be configured to link images based on one or more of audio data, voice data, biological data, temperature data, barometric pressure data, and people data that may be included in the metadata. For example, the linking module 660 may be configured to compare similarities in one or more of the audio data, voice data, biological data, temperature data, barometric pressure data, and people data that may correspond to different images to determine whether the different images were captured at the same event.

Accordingly, the system 600 may be configured to facilitate the linking and/or sharing of images based on the images likely being associated with the same event. The linking may therefore allow for different attendees of the event to better document the event in a simplified manner. Modifications, additions, or omissions may be made to the system 600 without departing from the scope of the present disclosure. For example, the system 600 may include any number of devices 606, storage blocks 610 and/or storage agents 604. Further, the location of components within the devices 606 is for illustrative purposes only and is not limiting. Additionally, although certain functions are described as being performed by certain devices, the principles and teachings described herein may be applied in and by any suitable element of any applicable storage network and/or storage system.

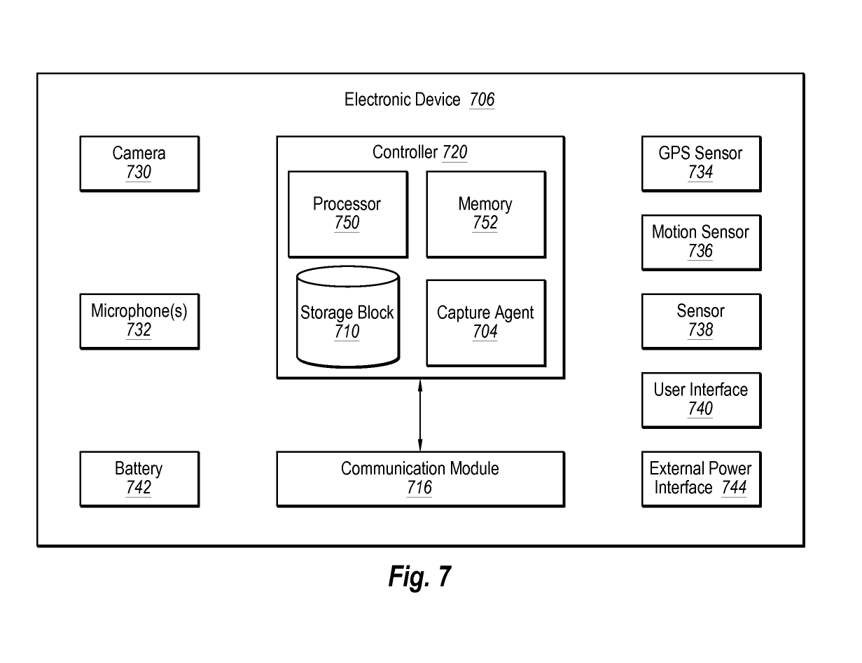

FIG. 7 illustrates an example electronic device 706 (referred to hereinafter as “device 706”) that includes a camera 730 and that may be integrated with a storage network, according to some embodiments described herein. The device 706 may be configured to generate image files such as video or photo files and in some embodiments may have a myriad of other functionality. For example, in some embodiments, the device 706 may be a smartphone or tablet device. In other embodiments, the device 706 may be configured as a standalone camera configured to generate image files. In some embodiments, any one of the devices of other figures discussed in the present disclosure may include the device 706.

The device 706 may include a computing system 720, a communication module 716, a camera 730, a microphone 732, a GPS sensor 734, a motion sensor 736, sensor(s) 738, and/or a user interface 740. The computing system 720 may be configured to perform operations associated with the device 706 and may include a processor 750, memory 752, and a storage block 710 analogous to the processors 650, memories 652, and storage blocks 610 of FIG. 6. The computing system 720 may also include a capture agent 704 that may act as a storage agent for the device 706. As detailed below, the capture agent 704 may be configured to integrate the device 706 with the storage network with respect to operations of the camera 730 of the device 706. The communication module 716 may be analogous to the communication modules 616 of FIG. 6 and may be configured to provide connectivity (e.g., wired or wireless) of the device 706 with a storage network and/or a communication network.

The camera 730 may include any camera known in the art that captures photographs and/or records digital video of any aspect ratio, size, and/or frame rate. The camera 730 may include an image sensor that samples and records a field of view. The image sensor, for example, may include a charge-coupled device (CCD) or a complementary metal-oxide semiconductor (CMOS) sensor. The camera 730 may provide raw or compressed image data, which may be stored by the controller 720 on the storage block 710 as image files. The image data provided by camera 730 may include still image data (e.g., photographs) and/or a series of frames linked together in time as video data.

The microphone 732 may include one or more microphones for collecting audio. The audio may be recorded as mono, stereo, surround sound (any number of channels), Dolby, etc., or any other audio format. Moreover, the audio may be compressed, encoded, filtered, compressed, etc. The controller 720 may be configured to store the audio data to the storage block 710. In some embodiments, the audio data may be synchronized with associated video data and stored and saved within an image file of a video. In these or other embodiments, the audio data may be stored and saved as a separate audio file. The audio data may also, for example, include any number of tracks. For example, for stereo audio, two tracks may be used. And, for example, surround sound 5.1 audio may include six tracks. Additionally, in some embodiments, the capture agent 704 may be configured to generate metadata based on the audio data as explained in further detail below.

The controller 720 may be communicatively coupled with the camera 730 and the microphone 732 and/or may control the operation of the camera 730 and the microphone 732. The controller 720 may also perform various types of processing, filtering, compression, etc. of image data, video data and/or audio data prior to storing the image data, video data and/or audio data into the storage block 710 as image files.

The GPS sensor 734 may be communicatively coupled with the controller 720. The GPS sensor 734 may include a sensor that may collect GPS data. Any type of the GPS sensor may be used. GPS data may include, for example, the latitude, the longitude, the altitude, a time of the fix with the satellites, a number representing the number of satellites used to determine GPS data, the bearing, and speed.

In some embodiments, the capture agent 704 may be configured to direct the GPS sensor 734 to sample the GPS data when the camera 730 is capturing the image data. The GPS data may then be included in metadata that may be generated for the associated image files and stored in the storage block 710. In some embodiments, during the creation of video data, the capture agent 704 may direct the GPS sensor 734 to sample and record the GPS data at the same frame rate as the camera 730 records video frames and the GPS data may be saved as metadata at the same rate. For example, if the video data is recorded at 24 fps, then the GPS sensor 734 may sample the GPS data 24 times a second, which may also be stored 24 times a second. As indicated above, the GPS data may also be used to determine camera orientation data.

The motion sensor 736 may be communicatively coupled with the controller 720. In some embodiments, the capture agent 704 may be configured to direct the motion sensor 736 to sample the motion data when the camera 730 is capturing the image data. The motion data may then be included in metadata that may be generated for the associated image files and stored in the storage block 710. In some embodiments, e.g., during the creation of video data, the capture agent 704 may direct the motion sensor 736 to sample and record the motion data at the same frame rate as the camera 730 records video frames and the motion data may be saved as metadata at the same rate. For example, if the video data is recorded at 24 fps, then the motion sensor 736 may sample the motion data 24 times a second, which may also be stored 24 times a second. The motion data derived from the motion sensor 736 may also be used to determine camera orientation data described above, which may also be stored.

The motion sensor 736 may include, for example, an accelerometer, gyroscope, and/or a magnetometer. The motion sensor 736 may include, for example, a nine-axis sensor that outputs raw data in three axes for each individual sensor: acceleration, gyroscope, and magnetometer, or it may be configured to output a rotation matrix that describes the rotation of the sensor about the three Cartesian axes. Moreover, the motion sensor 736 may also provide acceleration data. Alternatively, the motion sensor 736 may include separate sensors such as a separate one-three axis accelerometer, a gyroscope, and/or a magnetometer. The motion data may be raw or processed data from the motion sensor 736.

The sensor(s) 738 may include any number of additional sensors such as, for example, an ambient light sensor, a thermometer, barometric pressure sensor, heart rate sensor, other biological sensors, etc. The sensor(s) 738 may be communicatively coupled with the controller 720. In some embodiments, the capture agent 704 may be configured to direct the sensor(s) 738 to sample their respective data when the camera 730 is capturing the image data. The respective data may then be included in metadata that may be generated for the associated image files and stored in the storage block 710.

The user interface 740 may include any type of input/output device including buttons and/or a touchscreen. The user interface 740 may be communicatively coupled with the controller 720 via a wired or wireless interface. The user interface may provide instructions to the controller 720 from the user and/or output data to the user. Various user inputs may be saved in the memory 752 and/or the storage block 710. For example, the user may input a title, a location name, the names of individuals, etc. of a video being recorded. Data sampled from various other devices or from other inputs may be saved into the memory 752 and/or the storage block 710. In some embodiments, the capture agent 704 may include the data received from the user interface 740 and/or the various other devices with metadata generated for image files.

As indicated above, in some embodiments, the capture agent 704 may be configured to generate metadata for image files generated by the device 706 based on the GPS data, the motion data, the data from the sensor(s) 738, the audio data, and/or data received from the user interface 740. For example, the motion data may be used to generate metadata that indicates positioning of the device 706 during the generation of one or more image files. As another example, geolocation data associated with the image files, e.g., location of where the images were captured, speed, acceleration, etc., may be derived from the GPS data and included in metadata associated with the image files.

As another example, voice tagging data associated with the image files may be derived from the audio data and may be included in the corresponding metadata. The voice tagging data may include voice initiated tags according to some embodiments described herein. Voice tagging may occur in real time during recording or during post processing. In some embodiments, voice tagging may identify selected words spoken and recorded through the microphone 732 and may save text identifying such words as being spoken during an associated frame of a video image file. For example, voice tagging may identify the spoken word “Go!” as being associated with the start of action (e.g., the start of a race) that will be recorded in upcoming video frames. As another example, voice tagging may identify the spoken word “Wow!” as identifying an interesting event that is being recorded in the video frame or frames. Any number of words may be tagged in the voice tagging data that may be included in the metadata. In some embodiments, the capture agent 704 may transcribe all spoken words into text and the text may be saved as part of the metadata.

Motion data associated with the image files may also be included in the metadata. The motion data may include data indicating various motion-related data such as, for example, acceleration data, velocity data, speed data, zooming out data, zooming in data, etc. that may be associated with the image files. Some motion data may be derived, for example, from data sampled from the motion sensor 736, the GPS sensor 734 and/or from the geolocation data. Certain accelerations or changes in acceleration that occur in a video frame or a series of video frames (e.g., changes in motion data above a particular threshold) may result in the video frame or the video frames being tagged to indicate the occurrence of certain events of the camera such as, for example, rotations, drops, stops, starts, beginning action, bumps, jerks, etc. The motion data may be derived from tagging such events, which may be performed by the capture agent 704 in real time or during post processing.

Further, orientation data associated with the image files may be included in the metadata. The orientation data may indicate the orientation of the electronic device 706 when the image files are captured. The orientation data may be derived from the motion sensor 736 in some embodiments. For example, the orientation data may be derived from the motion sensor 736 when the motion sensor 736 is a gyroscope.

The GPS data may be coupled with motion sensor data to improve position and orientation data. The coupled GPS and motion sensor data may be stored with the image data as metadata.

Additionally, people data associated with the image files may be included in corresponding metadata. The people data may include data that indicates the names of people within an image file as well as rectangle information that represents the approximate location of the person (or person's face) within the video frame. The people data may be derived from information input by the user on the user interface 740 as well as other processing that may be performed by the device 706.

The metadata may also include user tag data associated with image files. The user tag data may include any suitable form of indication of interest of an image file that may be provided by the user. For example, the user tag data for a particular image file may include a tag indicating that the user has “starred” the particular image file, thus indicating a prioritization by the user of the particular image file. In some embodiments, the user tag data may be received via the user interface 740.

The metadata may also include data associated with the image files that may be derived from the other sensor(s) 738. For example, the other sensor(s) 738 may include a heart rate monitor and the metadata for an image file may include biological data indicating the heart rate of a user when the associated image or video is captured. As another example, the other sensor(s) may include a thermometer and the metadata for an image file may include the ambient temperature when the associated image or video is captured.

Other examples of metadata that may be associated with the image files may include time stamps and date stamps indicating the time and date of when the associated images or videos are captured. The time stamps and date stamps may be derived from time and date data provided by the user via the user interface 740, or determined by the capture agent 704 as described below.

Further, in some embodiments, the capture agent 704 may be configured to generate unique fingerprints for the image files, which may be included in associated metadata. The fingerprints may be derived from uniquely identifying content included in the image files that may be used to identify the image files. Therefore, image files that include the same content but that may be given different file names or the like, may include the same unique fingerprint such that they may identified as being the same. In some embodiments, the unique fingerprints may be generated using a cyclic redundancy check (CRC) algorithm or a secure hash algorithm (SHA) such as a SHA-256.

The metadata (e.g., geolocation data, voice tag data, motion data, geolocation data, audio data, voice tag data, motion data, biological data, temperature data, time stamp, date stamp, user tag data, barometric pressure data, people data, and/or a fingerprint data) may be stored and configured according to any suitable data structure associated with the image files. For example, for still image files (e.g., photographs) the metadata may be stored according to any suitable still image standard. As another example, for video image files, the metadata may be stored as described in U.S. patent application Ser. No. 14/143,335, entitled “VIDEO METADATA” and filed on Dec. 30, 2013, the entire contents of which are incorporated by reference herein.

The metadata generated from the geolocation data, voice tag data, motion data, people data, temperature data, time stamp data, date stamp data, biological data, user tag data, and/or fingerprint data may be used by the storage network to classify, sort, allocate, distribute etc., the associated image files throughout the storage network. For example, image files may be sorted according to where the associated images were captured, who is in the images, similar motion data (indicating similar activities) or the like based on the metadata. Accordingly, the capture agent 704 may be configured to generate metadata for the image files generated by the device 706 in a manner that facilitates integration of the image files (and consequently the device 706) in a storage network.

Accordingly, the device 706 may be configured to generate metadata that may be used to link image files based on events. Modifications, additions, or omissions may be made to the device 706 without departing from the scope of the present disclosure. For example, the device 706 may include other elements than those explicitly illustrated. Additionally, the device 706 and/or any of the other listed elements of the device 706 may perform other operations than those explicitly described.

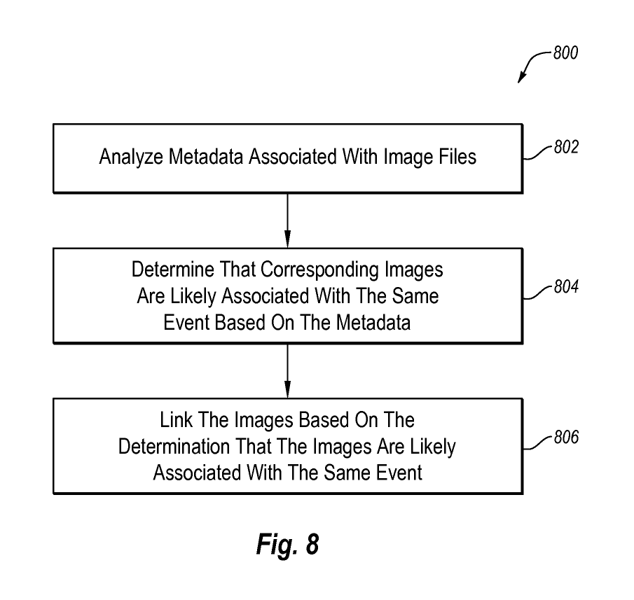

FIG. 8 is a flowchart of an example method 800 linking images, according to at least one embodiment described herein. One or more steps of the method 800 may be implemented, in some embodiments, by the linking module 660 of FIG. 6. Although illustrated as discrete blocks, various blocks may be divided into additional blocks, combined into fewer blocks, or eliminated, depending on the desired implementation.

The method 800 may begin at block 802, where metadata associated with multiple images may be analyzed. The images may correspond to image files that may include still image files and/or video image files. The metadata may include geolocation data, audio data, voice tag data, motion data, biological data, temperature data, a time stamp, a date stamp, user tag data, barometric pressure data, people data, and/or camera orientation data associated with the image files.

At block 804, it may be determined that the images are likely associated with the same event based on the analysis of the metadata, such as described above. The event may include a sporting event, a performance, a party, a vacation, and/or an activity. In some embodiments, it may be determined that the plurality of images are likely associated with the same event by determining that the plurality of images were captured within a particular distance of each other, determining one or more of a common landmark, structure and area of interest associated with the images and/or determining that the plurality of images were captured within a particular time and date.

At block 806, the images may be linked based on the determination that the images are likely associated with the same event. Accordingly, the method 800 may be used to link image files that are likely associated with the same event based on metadata associated with the image files.

The operations performed in the processes and methods of the method 800 may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 800 may include operations associated with sharing the plurality of image files with one or more users who contributed at least one of the plurality of image files. Additionally, in some embodiments, the method 800 may include operations associated with determining whether one or more of the plurality of images depict substantially the same location based on geolocation data, audio data, voice tag data, motion data, biological data, temperature data, a time stamp, a date stamp, user tag data, barometric pressure data, people data, and/or camera orientation data included in the metadata.

As described above, the embodiments described herein may include the use of a special purpose or general purpose computer including various computer hardware or software modules, as discussed in greater detail below. The special purpose or general purpose computer may be configured to execute computer-executable instructions stored on computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure. For example, although different operations are described with respect to different systems and figures in the present disclosure, any number of the operations described with respect to a particular embodiment described may be employed with respect to one or more other described embodiments.

What is claimed is:

1. A method comprising:
communicating a first electronic invitation for a first person to participate in image sharing of images corresponding to an event;
communicating a second electronic invitation for a second person to participate in image sharing of images corresponding to the event;
receiving, in response to the first electronic invitation, a first indication of participation by the first person in the image sharing;
receiving, in response to the second electronic invitation, a second indication of participation by the second person in the image sharing;
acquiring, in response to the first indication of participation, one or more first images based on first metadata of the one or more first images, the first metadata indicating capture of the one or more first images during the event, the one or more first images being captured by a first device associated with the first person;
acquiring, in response to the second indication of participation, one or more second images based on second metadata of the one or more second images, the second metadata indicating capture of the one or more second images during the event, the one or more second images being captured by a second device associated with the second person;
sharing, with the first person, the one or more second images based on the second metadata and the first indication; and
sharing, with the second person, the one or more first images based on the first metadata and the second indication.

2. The method of claim 1, further comprising:
determining that the first user is within an area that corresponds to the event; and
communicating the first electronic invitation in response to determining that the first user is within the area that corresponds to the event.

3. The method of claim 1, further comprising:
communicating a wireless beacon signal that corresponds to the event; and
communicating the first electronic invitation in response to an inquiry received from the first device, wherein the inquiry is communicated by the first device in response to the first device receiving the wireless beacon signal.

4. The method of claim 1, further comprising:
communicating an event tag to the first device; and
sharing the one or more first images with the second person based on the first metadata including the event tag.

5. The method of claim 4, wherein the first metadata includes the event tag based on the one or more first images being captured at a time, date, and location that correspond to the event.

6. The method of claim 1, further comprising:
receiving event information that corresponds to the event; and
including the first invitation in the event information; and
communicating the event information to the first device.

7. The method of claim 6, wherein the event information includes one or more of the following: an event time, an event location, an event date, an event tag, an event organizer identifier, and a sharing-host identifier.

8. The method of claim 1, further comprising:
determining that the first user is within an area that corresponds to the event at a time and date that correspond to the event; and
communicating the first electronic invitation in response to determining that the first user is within the area that corresponds to the event at the time and date that correspond to the event.

9. A method comprising:
receiving, from a first wireless device, a wireless beacon signal that corresponds to an event;
communicating, by a second wireless device, an indication of participation in image sharing with respect to the event in response to receiving the wireless beacon signal; and
receiving, by the second wireless device, one or more image files that correspond to one or more images captured during the event based on the indication of participation in the image sharing.

10. The method of claim 9, further comprising receiving, by the second wireless device, the one or more image files from the first wireless device via a wireless connection between the first wireless device and the second wireless device.

11. The method of claim 9, further comprising receiving, by the second wireless device, the one or more image files from a management system configured to share the one or more images with participants in the file sharing.

12. The method of claim 9, wherein the wireless beacon signal is a first wireless beacon signal and wherein the method further comprises transmitting, by the second wireless device, a second wireless beacon signal that corresponds to the event.

13. The method of claim 9, wherein the wireless beacon signal includes one or more of the following: a unique identifier of the event, an event time, an event location, an event date, an event tag, an event organizer identifier, and a sharing-host identifier.

14. The method of claim 9, further comprising communicating, by the second wireless device, an inquiry for event information in response to receiving the wireless beacon signal.

15. The method of claim 9, further comprising:
capturing, by the second wireless device, one or more other images during the event; and
sharing, by the second wireless device, the one or more other images with another participant in the image sharing based on the one or more other images being captured during the event.

16. The method of claim 15 wherein sharing the one or more other images includes one or more of the following: communicating the one or more other images to a management system configured to share the one or more other images with the other participant and communicating the one or more other images directly to another wireless device of the other participant.

17. The method of claim 15, further comprising including an event tag with metadata associated with the one or more other images based on the one or more other images being captured during the event; and
sharing the one or more other images based on the metadata including the event tag.

18. The method of claim 17, further comprising including the event tag in the metadata based on a determination that the one or more other images were captured at a time, date, and location that correspond to an event time, an event date, and an event location of the event.

19. One or more computer-readable storage media, configured to include instructions that cause a system to perform operations, the operations comprising:
communicating a wireless beacon signal that corresponds to an event;
communicating an electronic invitation for a person to participate in image sharing of images corresponding to an event in response to an inquiry received from a wireless device associated with the person, wherein the inquiry is communicated by the wireless device in response to the wireless device receiving the wireless beacon signal;
receiving, in response to the electronic invitation, a first indication of participation by the person in the image sharing; and
sharing, with the person, one or more images captured during the event based on the indication of participation.

20. The one or more computer-readable storage media of claim 19, wherein the wireless beacon signal includes one or more of the following: a unique identifier of the event, an event time, an event location, an event date, an event tag, an event organizer identifier, and a sharing-host identifier.
